(19) United States
(12) Patent Application Publication
(10) Pub. No.: US 2025/0263232 A1
(43) Pub. Date: Aug. 21, 2025

(54) Double-Deep Automated Storage and Retrieval System

(71) Applicant: Staples, Inc., Framingham, MA (US)

(72) Inventors: Harsha Amba, Tampa, FL (US); Aum Patel, Tampa, FL (US)

(21) Appl. No.: 18/443,109

(22) Filed: Feb. 15, 2024

(51) Int. Cl. B65G 1/04; B65G 1/06; B65G 1/12; B65G 1/137

(52) U.S. Cl. CPC B65G 1/0492; B65G 1/065; B65G 1/12; B65G 1/1376

(57) ABSTRACT

An automated sorting and packing system is described. A system may include a mobile vehicle body including a first mobile conveyor that moves with the mobile vehicle body. A system may include an item handling mechanism coupled with the mobile vehicle body and including one or more extendable members that move between a retracted position and an extended position to retrieve one or more items from one or more external shelves and move the one or more items onto the first mobile conveyor. A system may include one or more driving wheels coupled with a drive motor that cause the mobile vehicle body, mobile conveyor, and the item handling mechanism to move in an aisle.

### BACKGROUND

This application relates to warehouse fulfillment systems. For example, this application relates to an automated, efficient automated storage and retrieval system that includes various automated guided mobile vehicles that move items to or from a storage area.

Existing systems for fulfilling orders pick items into cartons one-by-one, often using human pickers that seek out items in a warehouse and then place them into shipping cartons. Human based systems result in errors, fatigue, and increased task completion time.

Some fulfillment systems use robots to transport shelves holding a plurality of items from a storage area to a picking station where a human places picks items from the shelves. Unfortunately, some of these systems transport entire shelving units of items, thereby resulting in significant wasted movement of robots and shelving units, thus being an inefficient use of space and resources. Other systems transport single items or move a single item per trip of the robot, which causes significant movement of robots, bottlenecks in space and other resource utilization, and other inefficiencies. These automated systems typically use just-in-time transportation of the shelves to the picking station, which results in downtime, increased quantities or conflicts for robots, and many other issues. Furthermore, these systems tend to be inflexible, are only useful in limited situations, and only useful for single item picks. These previous systems required human picking and/or high complexity, and the quantity of robots required were expensive, deployed slowly, and required substantial amounts of maintenance.

Furthermore, the shelving and robot layouts used by these systems tend to be inefficient due to the limitations of these robots, which reduces the amount and variety of items that may be stored and/or retrieved in a warehouse or fulfillment center.

### SUMMARY

An automated sorting and packing system can be configured to perform particular operations or actions by virtue of having software, firmware, hardware, or a combination of them installed on the system that in operation causes or cause the system to perform the actions. In some aspects, the techniques described herein relate to a system including: a mobile vehicle body including a first mobile conveyor that moves with the mobile vehicle body; an item handling mechanism coupled with the mobile vehicle body and including one or more extendable members that move between a retracted position and an extended position to retrieve one or more items from one or more external shelves and move the one or more items onto the first mobile conveyor; and one or more driving wheels coupled with a drive motor that cause the mobile vehicle body, mobile conveyor, and the item handling mechanism to move in an aisle.

In some aspects, the techniques described herein relate to a system, wherein the mobile vehicle body includes: one or more guide wheels oriented horizontally to contact one or more external guide rails extending down a length of the aisle, the one or more external guide rails aligning the mobile vehicle body in the aisle.

In some aspects, the techniques described herein relate to a system, wherein the system further includes: one or more vertical support rails coupled with and extending vertically from the mobile vehicle body; a vertical carriage coupled with and moving vertically along the one or more vertical support rails, the vertical carriage holding the item handling mechanism; and a second motor mounted to the mobile vehicle body and adapted to drive a belt extending along the one or more vertical support rails, the vertical carriage coupled with the belt.

In some aspects, the techniques described herein relate to a system, wherein the mobile vehicle body includes: two or more mobile conveyors coupled with a frame of the mobile vehicle body, each of the two or more mobile conveyors being accessible to the item handling mechanism, the two or more mobile conveyors including the first mobile conveyor and a second mobile conveyor, the first mobile conveyor being located vertically above the second mobile conveyor.

In some aspects, the techniques described herein relate to a system, wherein the item handling mechanism is configured to remove an item from the second mobile conveyor and place the item on the first mobile conveyor.

In some aspects, the techniques described herein relate to a system, wherein: the one or more extendable members include one or more grasping fingers at an end of the one or more extendable members, the one or more grasping fingers pivoting between a vertical position and a horizontal position, the horizontal position providing contact with the one or more items handled by the item handling mechanism, the contact pulling the one or more items from the one or more external shelves when the item handling mechanism moves into the retracted position.

In some aspects, the techniques described herein relate to a system, wherein: the one or more extendable members include one or more linear rails supporting one or more telescoping side members, a belt, and a motor engaging with the belt, the one or more telescoping side members being coupled with the belt so that when the motor rotates the belt, the belt causes the one or more telescoping side members to extend along the one or more linear rails and move the item handling mechanism into the extended position.

In some aspects, the techniques described herein relate to a system, further including: a vertical carriage moving vertically along a vertical support rail, the vertical support rail extending vertically upward from the mobile vehicle body, the vertical carriage including a horizontal platform extending horizontally away from the vertical support rail, the horizontal platform providing vertical support to the item handling mechanism.

In some aspects, the techniques described herein relate to a system, further including: a first horizontal gear coupled with the horizontal platform and mounted in a horizontal orientation, the item handling mechanism including a motor that engages with the first horizontal gear to cause the item handling mechanism to rotate relative to the first horizontal gear, the rotation of the item handling mechanism allowing the one or more extendable members to extend in along two or more different directions.

In some aspects, the techniques described herein relate to a system, further including: wherein a second horizontal gear is mounted to the motor and interacts with a belt, the belt extending around the first horizontal gear and the second horizontal gear, the motor being coupled with and rotating with the item handling mechanism, the motor causing the item handling mechanism to rotate relative to the horizontal platform when the motor rotates the second horizontal gear, the first horizontal gear being rigidly mounted to the horizontal platform.

In some aspects, the techniques described herein relate to a system, wherein: the one or more extendable members of the item handling mechanism have a reach length configured to extend into one or more external storage shelves, the one or more external storage shelves including a front storage shelf and a back storage shelf, the one or more extendable members being adapted to access both the front storage shelf and the back storage shelf, the back storage shelf including the one or more external shelves from which the one or more items are retrieved by the item handling mechanism.

In some aspects, the techniques described herein relate to a system, wherein: the one or more driving wheels are configured to move the mobile vehicle body to an unloading zone at which the first mobile conveyor rotates to transfer the one or more items off from the first mobile conveyor.

In some aspects, the techniques described herein relate to a method including: retrieving a first item from a first location on one or more external storage shelves using an item handling mechanism coupled with a mobile vehicle; transferring the first item from the item handling mechanism to a first mobile conveyor coupled with the mobile vehicle; navigating the mobile vehicle to a transfer location; and transferring the first item from the first mobile conveyor including rotating the first mobile conveyor at the transfer location.

In some aspects, the techniques described herein relate to a method, further including: retrieving a second item from a second location on the one or more external storage shelves using the item handling mechanism; and transferring the second item from the item handling mechanism to the first mobile conveyor, the first mobile conveyor holding the first item and the second item simultaneously.

In some aspects, the techniques described herein relate to a method, further including: transferring the second item with the first item from the first mobile conveyor including rotating the first mobile conveyor at the transfer location.

In some aspects, the techniques described herein relate to a method, further including: transferring a second item from a second mobile conveyor coupled with the mobile vehicle to the first mobile conveyor using the item handling mechanism.

In some aspects, the techniques described herein relate to a method, wherein transferring the second item from the second mobile conveyor to the first mobile conveyor includes: moving the item handling mechanism to a first height of the second mobile conveyor; rotating the second mobile conveyor to position the second item within reach of the item handling mechanism; extending the item handling mechanism to interact with the second item on the second mobile conveyor; retracting the item handling mechanism holding the second item; moving the item handling mechanism to a second height of the first mobile conveyor; and extending the item handling mechanism to move the second item onto the first mobile conveyor.

In some aspects, the techniques described herein relate to a method, further including: retrieving a second item from a second location on the one or more external storage shelves using the item handling mechanism; and transferring the second item from the item handling mechanism to a second mobile conveyor coupled with the mobile vehicle.

In some aspects, the techniques described herein relate to a method, wherein: the second item is retrieved from a front storage shelf and the first item is retrieved from a back storage shelf of the one or more external storage shelves; the first item is an assigned item for retrieval by the item handling mechanism and the second item is an unassigned item; and the second item is retrieved by the item handling mechanism prior to the first item being retrieved by the item handling mechanism.

In some aspects, the techniques described herein relate to a method, further including: retrieving the second item from the second mobile conveyor using the item handling mechanism; moving the item handling mechanism holding the second item to a height of the front storage shelf; rotating the item handling mechanism to face the item handling mechanism toward the front storage shelf; and extending the item handling mechanism and the second item to place the second item on the front storage shelf.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated robotic fulfillment system, which may use technologies, such as a double-deep automated storage and retrieval system.

FIG. 2 illustrates an example layout of a portion of a fulfillment center used in the automated robotic fulfillment system.

FIG. 3A is a flowchart of an example method for retrieving items for one or more orders from a storage area using an ASRS vehicle.

FIG. 3B is a flowchart of an example method for retrieving an item, for example, from a back shelf in a double-deep shelving configuration.

FIGS. 3C, 3D, and 3E depict a flowchart of an example method for retrieving an item using an ASRS vehicle with a telescoping, rotating item handling head.

FIGS. 4A-4C illustrate various views of an example ASRS vehicle.

FIGS. 5A-5C illustrate perspective views of an example ASRS vehicle with its vertical carriage and item handling mechanism in different positions.

FIGS. 6A-6E illustrate various views of an ASRS body and other portions of an ASRS vehicle.

FIGS. 7A-7F illustrate various views and configurations of a vertical carriage.

FIGS. 8A-8H illustrate various views of an example implementation of an item handling mechanism, which may be coupled with a vertical carriage.

FIGS. 9A-9F illustrate various views of an item handling mechanism 444 in a retracted and extended position as well as various components that facilitate its extension functionality.

FIG. 10 is a block diagram illustrating an example computing system.

### DESCRIPTION

The technology described herein may be used in an automatic, robotic replenishment, organizing, or fulfillment system in a warehouse. For instance, the technology described herein may be applied in various contexts to move items between storage and fulfillment areas in a warehouse or fulfillment center. For instance, items of one or more types or SKUs (stock keeping units) may be stored in a mobile storage unit, which may be retrieved from a high-density storage area by technologies described herein and conveyed to other areas of a fulfillment center where other mechanisms (e.g., diverters, pickers, robotic arms, etc.) may be used to pick the items into shipping cartons in order to fulfill orders for those items. Additionally, technologies described herein may be used to replace, replenish, or otherwise store items in the high-density storage area. This technology improves the efficiency of storage and retrieval of items, among other benefits described below. It should be noted that the configurations may take various forms and have various materials without departing from the scope of this disclosure.

Depending on the implementation, the technology may include automated guided vehicles or AGVs, which may be mobile vehicles that move within an operating environment to perform operations. While there are multiple types of AGVs that may be used in the same environment or in coordination to perform operations, some implementations are described herein. Implementations of AGVs may also be referred to as automated storage and retrieval (ASRS) vehicles.

The technology is designed to increase the picking capacity in a fulfillment center by making various improvements over previous technologies, such as those described in the Background. For instance, the example ASRS vehicle(s) described may increase the storage and picking capacity by increasing the robot picking unit reach length to reach up to two items (e.g., totes, mini-pallets, mobile storage units, etc.) deep in a shelving area, which reduces the number of aisles required by half. Similarly, the example ASRS vehicles are designed to increase the stability and vertical reach of the ASRS vehicle (e.g., up to sixteen feet or more), which increases the density of items that can be stored in a given area of a building.

In some implementations of the technology, the ASRS vehicle may use an item handling device or mechanism (also referred to as item handling head) to retrieve items from external storage units and place them on a conveyor coupled with the ASRS vehicle. For instance, the conveyor may be coupled or integrated with the ASRS vehicle's body in order to move with the vehicle and receive items from the item handling head. Accordingly, the ASRS vehicle may retrieve items from external storage shelving and place them on a mobile conveyor that moves with the ASRS vehicle (e.g., down a length of an aisle).

The ASRS vehicle, upon completing an assigned set of picks/retrievals from the aisle (e.g., where a set of items or totes are placed by the item handling head onto the mobile conveyor(s)), may travel to a unloading point or transfer station at which it may stop or dock to unload the set of items. In some implementations, the ASRS vehicle may rotate the conveyor to cause the set of items to be unloaded at the unloading points. The items may be conveyed onto an external conveyor, chute, cart, or another mechanism that allows them to be processed elsewhere in the facility. Accordingly, because multiple items may be moved simultaneously on a conveyor, they may be unloaded more quickly than where an item handling mechanism individually unloads them, for instance, from portable shelves. This process may be reversed in order to quickly transfer items on to the mobile conveyor and then onto storage shelves by the ASRS vehicle.

Example implementations of the ASRS vehicle are described herein that provide benefits of both track-mounted and completely free-standing robots. For instance, the technology allows the ASRS vehicle to be very stable in its direction of movement thereby reducing the probability that it will tip over. Accordingly, the ASRS vehicle may move quickly and reach greater heights, for example, due to its long body (e.g., including one or more conveyors). In some implementations, while the ASRS vehicle may be guided by external rails or other structures, it may be decoupled from top or bottom rails, which allows the vehicle to be easily removed from an aisle or guides (e.g., by merely navigating it beyond the limits of the aisle or rails) to allow maintenance, replacement, etc. Accordingly, using the technologies described herein, some implementations of the ASRS vehicle may be more easily maintained than mounted, crane robots while being more stable and efficient than free-moving robots.

Among other benefits described herein, the technology provides for an item handling head that, due in part to its telescoping and rotating design (and in part due to the stability of the ASRS vehicle), allows it to reach double deep shelves. The technology may include one or more mobile conveyors on which items may be placed, thereby providing increased carrying and buffering capacity to the ASRS vehicle and allowing it to move items more efficiently. For example, the double-deep reach of the item handling head and quick-loading and unloading buffering capacity of the mobile conveyors improves overall performance of the fulfillment center, for instance, by providing the improved mobile buffer, the technology improves the speed, timeliness, and efficiency of the automated storage and retrieval system.

This technology substantially improves the picking process as multiple items (e.g., in totes/mobile storage units) from the system can be transported at one time and the effort (e.g., by automatic guided vehicles, conveyors, or other equipment) required to move the items into or out of the storage area is reduced.

Various operations, features, and components for implementing the technology are described throughout this disclosure, such as in reference to the examples illustrated in the figures.

The technology described herein relates to an automated system comprising various software and hardware devices, for example, an automated robotic picking system, an automated storage and retrieval system, or other technology. The technology may include beneficial configurations, operations, features, and interactions. Among other benefits, the technology described herein improves upon that described in the Background Section. For instance, the technology provides robotic devices, systems, methods, and other aspects that can more efficiently retrieve items from or place items in a storage area.

In some implementations, the technology may provide integration, coordination, and control of various systems to intelligently move items and reduce human interaction, which increases speed and accuracy.

In some instances, the technology may include various computing devices or controllers coupled with equipment, such as the robotic arm(s), optical sensors or cameras, AGV(s), motors, consolidation area transfer mechanisms, conveyors, other equipment, sensors (e.g., optical sensors, scanners, etc.) human interface system(s), and other devices. In some implementations, the components may communicate with each other directly, for instance, via a network or communication bus. In some implementations, a central control system, such as a warehouse management system (WMS) 104 or other system may receive signals, perform computations, and issue commands to other devices.

Features of the technology described herein can be integrated into any logistics system, dispatch system, warehouse execution system, warehouse management system, a robot execution server, etc., to coordinate the operations of various systems, information, and devices in a fulfillment system. The technology described herein may provide a fully or partially automated system that provides redundancy, reduces the number of operations, and provides many other benefits described herein. The technology beneficially improves productivity and throughput, increases asset utilization, increases space utilization, and lowers cycle time and labor costs. These benefits, in turn, lead to shorter delivery times and result in significant time and resource savings along with reduced error rates.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

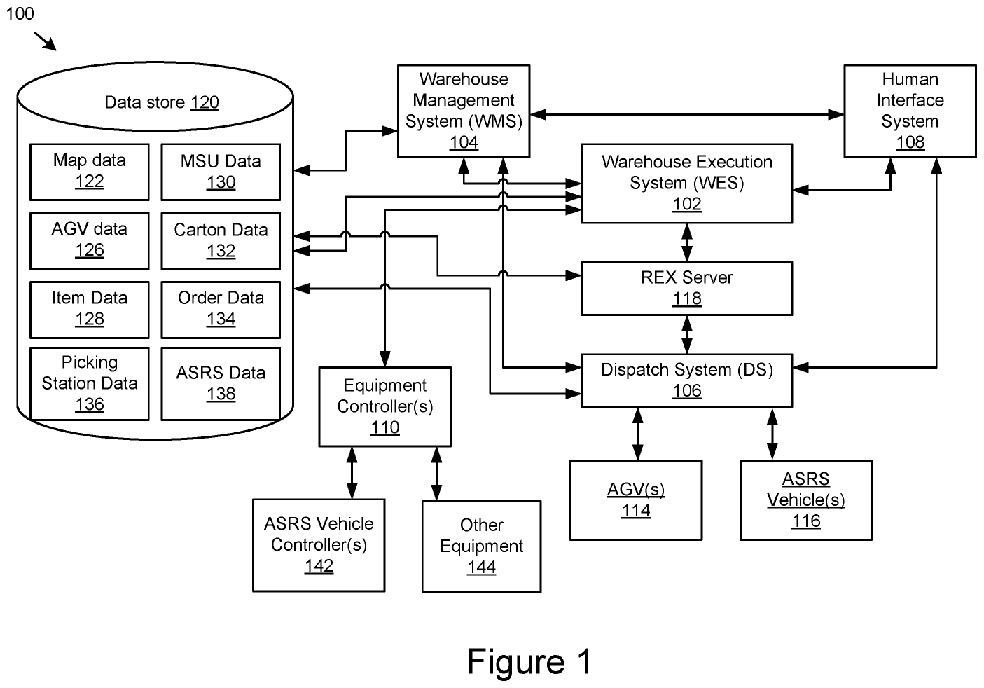

FIG. 1 depicts an example system 100 and data communication flow for implementing an automated robotic fulfillment system, which may use the technologies, such as the double-deep automated storage and retrieval system, described in further detail herein. The system 100 includes a warehouse execution system (WES) 102. The WES 102 is coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include picking station component(s) or other systems, ASRS vehicle controller(s) 142, and/or other equipment 144, such as optical sensors or cameras, conveyors, printers, conveyors, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. In further implementations, these routines, or a portion thereof, may be embodied in electrical hardware that is operable to carry out the operations, acts, and/or functionality described herein.

For example, the WES 102 may be communicatively coupled with scanner(s), carton conveyor(s), item conveyor(s), diverter(s), picking station component(s), camera(s), robotic arms, and other equipment 144 either directly or via the equipment controller(s) 110, which may be programmable logic controllers (e.g., conveyor controllers, conveyor scanner controllers, automated induction equipment controllers, other warehouse equipment controllers, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110, ASRS vehicle controller(s) 142, and/or other systems to perform operations respective to the technology described herein. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110, ASRS vehicle controller(s) 142, REX server 118, dispatch system 106, and/or other equipment. The WES 102 or WMS 104 may communicate with equipment or a human-interface system 108, which may provide instructions for picking items or correcting errors, for instance.

The other equipment 144 may include an item handling station, other box erectors, label applicators, scanners, picking equipment, or other devices for inducting or moving items, mobile storage units, cartons, or other objects in the system; scanners that may include optical, radio, or other scanners or sensors that scan items, containers, totes, mobile storage units, or cartons to identify them; conveyors that may include one or more conveyor belts or other devices that convey objects (e.g., items, mobile storage units, cartons, or other objects), for instance, as described herein Other equipment 144 may include various other devices, such as label applicators, carton-closing equipment, control systems, printers, actuators, motors; or various other devices.

The REX server 118 may, in some implementations, include one or more hardware and/or virtual servers programmed to perform operations, acts, and/or functionality described herein. The REX server 118 may generate a schedule that defines the route for one or more AGVs 114 and/or one or more ASRS vehicle 116. For a given AGV 114 or ASRS vehicle 116, the REX server 118 may generate a schedule and transmit it to the dispatch system 106, equipment controller(s) 110, and/or an ASRS vehicle controller 142, which may, in turn, deploy an AGV 114 or ASRS vehicle 116 according to the schedule or instruction. In some implementations, the dispatch system 106 instructs the ASRS vehicle 116 to proceed to various locations in an aisle or perform various other operations described herein according to the schedule/instruction. The schedule of each of the AGVs 114 and/or ASRS vehicles 116 may be coordinated such that an optimal flow of items in a warehouse or fulfillment center can be achieved. For example, as described elsewhere herein, the REX server 118, WES 102, or other component of the system 100 may instruct an ASRS vehicle 116 to retrieve a defined mobile storage unit or tote from a storage area and transport it to a transfer location at which it may be unloaded, for instance, from the mobile conveyor on the ASRS vehicle 116.

In some implementations, the REX server 118 may include or may communicate with a routing engine, which may route ASRS vehicles 116 and/or objects (e.g., items, mobile storage units, etc.) in a fulfillment center.

The dispatch system 106 may be electronically communicatively coupled to a plurality of automated guided vehicles (AGVs) 114 or 116, directly or via ASRS vehicle controllers 142, for example. In some implementations, the dispatch system 106, or elements thereof, may be integrated with or communicatively coupled with the REX server 118. The dispatch system 106 includes hardware and software configured to dispatch automated vehicles and is coupled for communication the components of the system 100 to receive instructions and provide data.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units. Various configurations of AGVs 114 may be used, such as those with forklifts, robotic arms, or other mechanisms for manipulating items. In some implementations, in addition to or in lieu of AGVs 114, conveyors or other conveyance mechanisms may be used to transport mobile storage units (e.g., pallets, totes, etc.) or other objects.

An ASRS vehicle 116 may include a robotic, mobile vehicle that allows automated storage and retrieval of items, such as mobile storage containers, to/from a storage area of an operating environment, such as a warehouse or fulfillment center. An ASRS vehicle 116 may be fully or partially automated based on certain instructions or triggers, such as an instruction to navigate to, retrieve, and/or deliver a defined item to a transfer point, where the item may be removed or moved to another device for downstream processing (e.g., transferred to a picking station at which items may be picked from a mobile storage container).

Depending on the implementation, the ASRS vehicle 116 may include a mobile vehicle body that moves within an operating environment, such as between shelves in an aisle. An ASRS vehicle 116 may include one or more conveyors, which may facilitate storage while the vehicle is moving, transfer of items onto/off of the vehicle, buffering of operations (e.g., where an item is stored while a second-deep item is being retrieved, where items are stored to allow multiple items to be retrieved in a single trip in the aisle), or other functionality. Although implementations described herein describe mobile conveyors as being integrated with the vehicle body, they may be integrated with an item handling head (e.g., an item handling head may include a vertical carriage and an item handling mechanism), or attached to the vehicle body, such as where the mobile conveyors are on a separate, couplable cart, although other implementations are possible and contemplated herein.

In some implementations, the ASRS vehicle 116 may include various item handling mechanisms, such as the examples described herein, that allow it to retrieve items from externals shelves and place items on an internal storage or transfer device, such as the example mobile conveyors described. While various example systems are shown and described, it should be noted that others are possible and contemplated herein. For example, while a rotating, telescoping item handling head is described being coupled with a vertical carriage that travels vertically along one or more vertical support rails, other implementations, such as a robotic arm, actuatable forklift, sliding platform, or other devices are possible and contemplated. In some implementations, the item handling mechanism may include a telescoping mechanism that rotates on a platform, the configuration of which allows a more densely packed shelving in a storage area, such as by allowing the item handling mechanism to access one, two, three, or another quantity deep of shelves. The configuration of the ASRS vehicle 116 and other components allow improved range of motion and stability of the item handling head to provide these and other benefits, as described in further detail throughout this disclosure.

The ASRS vehicle controllers(s) 142 may include computing devices or programmable logic controllers (e.g., conveyor controllers, motor controllers, etc.) that provides control, communication, and/or other interaction with ASRS vehicles 116 and/or their components. For instance, an ASRS vehicle controller 142 may be mounted to an ASRS vehicle 116 or communicatively coupled therewith to receive sensor data (e.g., guidance sensors that sense guidance markers, optical scanners that scan item identifiers, position sensors that detect conveyor, carriage, motor, or other positions, or otherwise), provide instructions (e.g., to a motor to perform certain movements), or other execute other operations, as described elsewhere herein. The ASRS vehicle controller(s) 142 may be communicatively coupled with the equipment controller(s) 110, WES 102, REX server 118, dispatch system 106, or other devices of the system 100.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 or ASRS vehicle controller(s) 142 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WES 102 or WMS 104 may be performed by the equipment controller(s) 110, ASRS vehicle controller(s) 142, or REX server 118, or some operations described in reference to the equipment controller(s) 110, ASRS vehicle controller(s) 142, REX server 118, or picking station component(s) may be performed by the WMS 104 or WES 102.

The human interface system 108 may, in some implementations, include one or more hardware and/or virtual servers or software routines storable in one or more non-transitory memory devices and executable by one or more processors to perform operations, acts, and/or functionality, such as interaction by humans with machinery or to receive instructions to perform operations relative to items or machinery. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the data with the WES 102, WMS 104, or other components of the system in real time, in batches, as requested by the components of the system, etc.

The human interface system 108 may receive scan data from a client device based on a user scanning a barcode or other identifier of an item, conveyance device, tote, etc. The human interface system 108 may provide instructions to users indicating to place certain items, totes, containers, mobile storage units, etc., at certain locations, remedy errors or exceptions, or perform other actions. For instance, the human interface system 108 may instruct a user to place an item on a consolidation tray, clear a clog in a chute or transfer area of a picking station, correct an error at the buffer system, or perform other actions.

In some implementations, for example, an equipment controller 110 may detect that an error has occurred with an ASRS vehicle 116. The equipment controller 110 or ASRS vehicle controller 142 may communicate with the human interface system 108 directly or via a WES 102 or other component to issue instructions to a human agent to clear the error.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, pallet data, AGV data 126, item data 128, MSU (mobile storage unit) data 130, carton data 132, order data 134, picking station data 136, ASRS data 138, or other data. In some instances, the data store 120 may also include system attributes, sensor data, labels, system health, etc.

The data store 120 may be included in the WES 102, WMS 104, equipment controller(s) 110, REX server 118, or in another computing system and/or storage system distinct from but coupled to or accessible by the WES 102, WMS 104, REX server 118, equipment controller(s) 110, ASRS vehicle controller(s) 142, or other components of the system 100. The WES 102, WMS 104, human interface system 108, REX server 118, equipment controller(s) 110, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2- or 3-dimensional layout of the facility including example locations of storage units, shelves, totes, or other items, automated picking station(s), carton receiving areas/spaces, mobile storage unit receiving area/spaces, conveyors, equipment, storage shelving units, buffer shelves, items, AGVs 114, ASRS vehicles 116, conveyors, etc. Map data 122 may indicate the attributes of the distribution facility, including attributes of zones/areas of a warehouse. For example, attributes of zones may include the number, quantity, and location of shelving units or bays, storage units, items, boxes/cartons, guidance system locators or markers, etc.

The AGV data 126 may describe the state of an AGV 114, such as operational state, health, location, battery life, storage capacity, objects (e.g., items, mobile storage units, totes, pallets, etc.) being carried, cartons, whether a picker is assigned to it, etc.

The item data 128 may describe items in a distribution facility. The item data 128 may include unique identifiers for these items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit, mobile storage unit partition, tote, conveyance device, pallet, shipping carton, etc.), other attributes of the item (e.g., size, description, weight, quantity of items in a package, color, quantity of packages in a container, etc.), item inventory, or mapping of items to storage units, orders, conveyor locations, picking station(s), trays in a picking station, pallets, totes, etc. In some implementations, the item data 128 may include the quantity of particular items a mobile storage unit contains, the current location of a storage unit, a storage location of items and/or storage units, and other data. For instance, the item data 128 may include visual aspects, labels, QR codes, identifying markers, etc., that may be used by the WES 102, WMS 104, or equipment controller(s) 110, etc., to identify items, for example, based on a scan of an item.

The MSU data 130 may include information about mobile storage units and/or containers in the system, such as a unique identifier or license plate number for each mobile storage unit or container, a mobile storage unit or container type, the zones a mobile storage unit will visit, the current or assigned location of a mobile storage unit, and the priority for the mobile storage unit. For instance, the MSU data 130 (or map data 122) may indicate an aisle, distance into an aisle, side of an aisle, shelving unit, shelf height, shelf depth (e.g., whether it is in a front shelf or a back shelf where double deep or other depths of shelves are used), or other information. The MSU data 130 may include a list indicating the items, item types, and/or the quantity of items a mobile storage unit (or a partition thereof) contains or should contain (e.g., its maximum or assigned capacity).

The carton data 132 may include various attributes describing box formers, available box sizes, box sizes associated with a box former, box size(s) associated with an order, the state of each box former, box former queues, or other data described herein. For example, the carton data 132 may include license plate numbers or other identifiers on cartons, status and locations of cartons in the systems (e.g., on conveyors), orders or items assigned to cartons, and other data.

Order data 134 may include data pertaining to orders to-be-fulfilled, being fulfilled, and/or already fulfilled in the fulfillment center. For example, the order data 134 may include tables or other files indicating which items are associated with orders, attributes of the items, attributes of the orders, shipping information, box size needed for the items, picking stations to which orders are assigned, status information, or other information for orders.

Picking station data 136 may include various data describing a picking station, such as its location, status, orders assigned to the station, mobile storage unit assigned to or at the station, cartons assigned to or at the station, or other data. For example, as described below, orders and associated items may be assigned to be picked at a station.

ASRS data 138 may include data describing the locations, storage state, items, or other attributes of ASRS vehicles 116. The ASRS data 138 may additionally or alternatively describe the current state, health, location, battery life, storage capacity, items being carried, pending task, position of the item handling head, position of each mobile conveyor, or other attributes of an ASRS robot/vehicle 116, its components, or its sensors, for example. For instance, the ASRS data 138 may indicate a current or assigned position of each item on the ASRS vehicle, such as where or whether it is on each mobile conveyor, the item handling head, staging conveyor, or otherwise.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

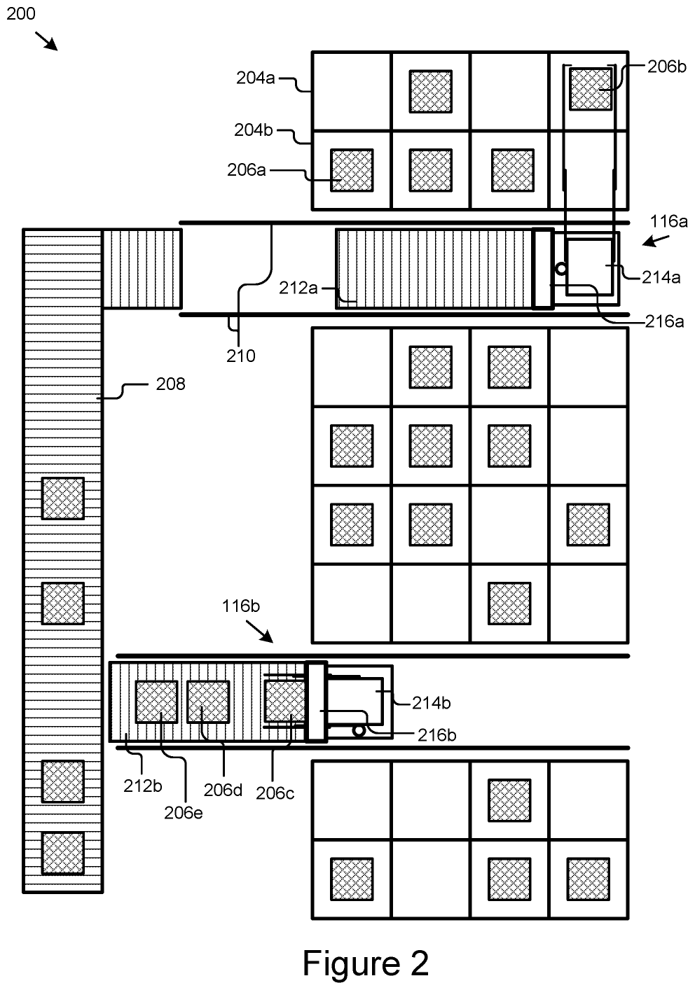

FIG. 2 illustrates an example layout 200 of a portion of a fulfillment center used in the automated robotic fulfillment system. For instance, the layout 200 illustrates a top-down view of an operating environment in which multiple ASRS vehicles 116 operate between storage shelves 204. It should be noted that the layout 200 is provided as an illustrative example of the technology described herein and that other layouts, configurations, and uses may be used. Additionally, the other figures herein illustrate example configurations and implementations of this technology. While certain examples are described, the operations, components, and features described herein may be modified, interchanged, omitted, or augmented without departing from the scope of this disclosure. It should be noted that while certain movements, interactions, paths, locations, and devices are illustrated, other implementations are possible and contemplated herein.

It should be understood that various facilities may include different configurations. For instance, a fulfillment center, distribution facility, or another location may use some or all of the aspects of the example layout. It should be noted that other configurations, components, or layouts are possible and contemplated herein, and the examples are provided by way of illustration.

In the illustrated example, two ASRS vehicles 116a and 116b are illustrated in two separate aisles, for example, where the aisles extend between storage shelves 204. In the illustrated example, the storage shelves 204 are in a double deep configuration (e.g., where there are four shelves or shelving unit bays between aisles), so that an item handling head 214 that is configured to access two shelves deep may reach beyond a front shelf to access a back shelf, although other implementations are possible and contemplated herein, such as single or triple deep shelves.

In the illustrated example, the shelves are shown to the right and left of an ASRS vehicle 116 in an aisle but, in some implementations, shelves may also be at an end of an aisle and the item handling head 214 may be adapted to rotate to access the shelves at the end of the aisle/in front of the ASRS vehicle 116.

The shelves may be flat, open at the bottom, or have various other configurations to allow them to hold items 206. In some implementations, as illustrated, the items 206 may include mobile storage units where each shelf holds a single mobile storage unit. Although other implementations are possible, a mobile storage unit may include a tote with a bottom and four sides in which objects may be stored. The mobile storage unit may include one or more internal dividers, a lid, one or more access doors in the top or side(s), handling mechanism interface mechanisms, or other components. The mobile storage units may have a bar code, QR code, RFID chip, or other ID that allows it to be identified and tracked in a fulfillment center, for example, by a scanner coupled with an ASRS vehicle 116 (e.g., on an item handling head 214). In some implementations, the shelves may extend vertically well beyond the reach of a human and, potentially, limited by a ceiling in a building, such as 8, 10, 16, or other feet from the floor. Accordingly, the shelves 204 may provide high density storage area for items 206, such as the mobile storage units (which may hold one or more types of items 206 or objects).

In the illustrated example layout, an ASRS vehicle 116 may be positioned between two guide rails 210 that that extend into the aisle and improve guidance and/or stability of the ASRS vehicle 116. The rails 210 may be mounted to shelves 204 or may be mounted to a floor and may support and/or guide an ASRS vehicle 116. Although not shown in the illustrated examples, in some implementations, the rails 210 may couple the ASRS vehicle 116 to the floor to prevent it from tipping, guide it, locate it, move it, or otherwise, so that it may move more quickly and accurately than would be possible with other systems. Additionally, or alternatively, one or more power and/or other rails may be disposed along the support rails and/or shelves. The power rails may, for instance, provide power via brushes, etc., to the ASRS vehicle 116.

In the depicted example, the ASRS vehicle 116 includes one or more mobile conveyors 212 coupled with or integrated with the body of the vehicle. The mobile conveyors 212 may store items 206 during movement of the ASRS vehicle 116 in an aisle or elsewhere. In some implementations, one or more of the mobile conveyors 212 may rotate to allow additional items 206 to be stored thereon and/or transferred thereto/therefrom.

The ASRS vehicle 116 may include a vertical rail 216 or mast that allows an item handling head 214 to move upward or downward and access external shelves at various heights. As described in further detail below, some implementations of the ASRS vehicle 116 may be configured to allow the item handling head 214 to access multiple mobile conveyors 212 on the vehicle body.

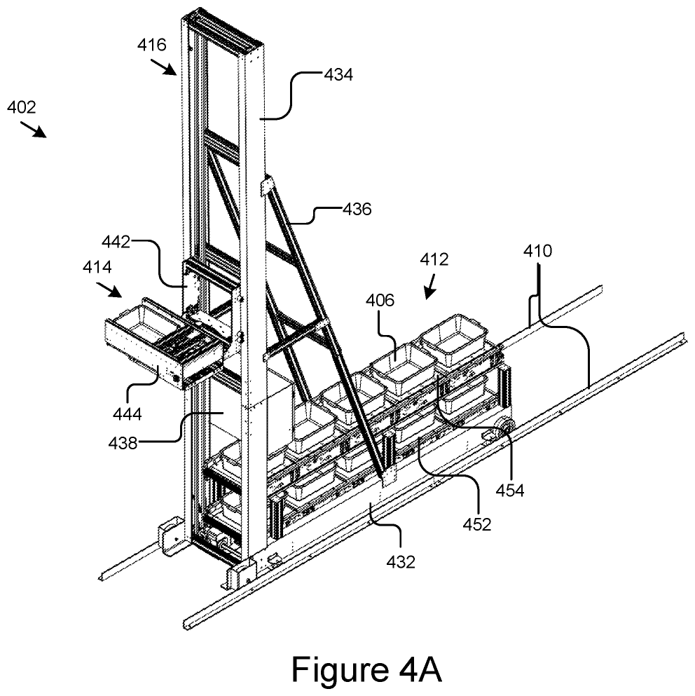

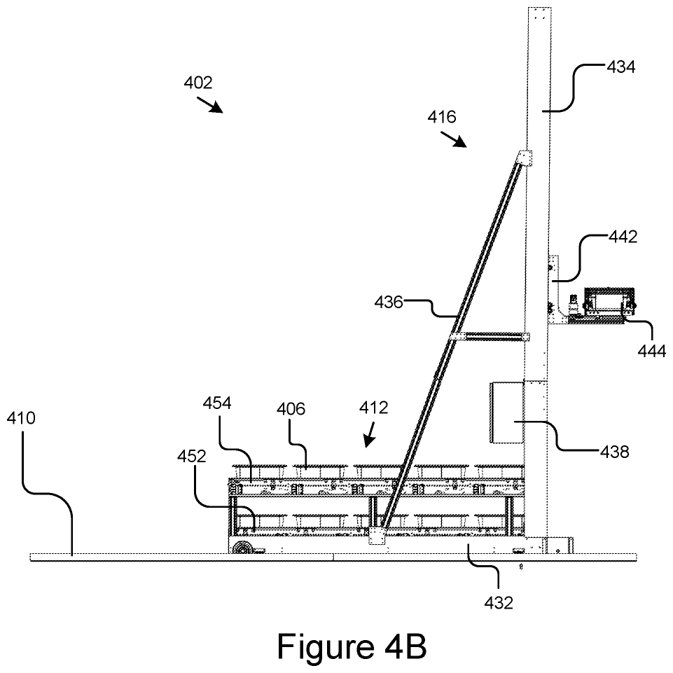

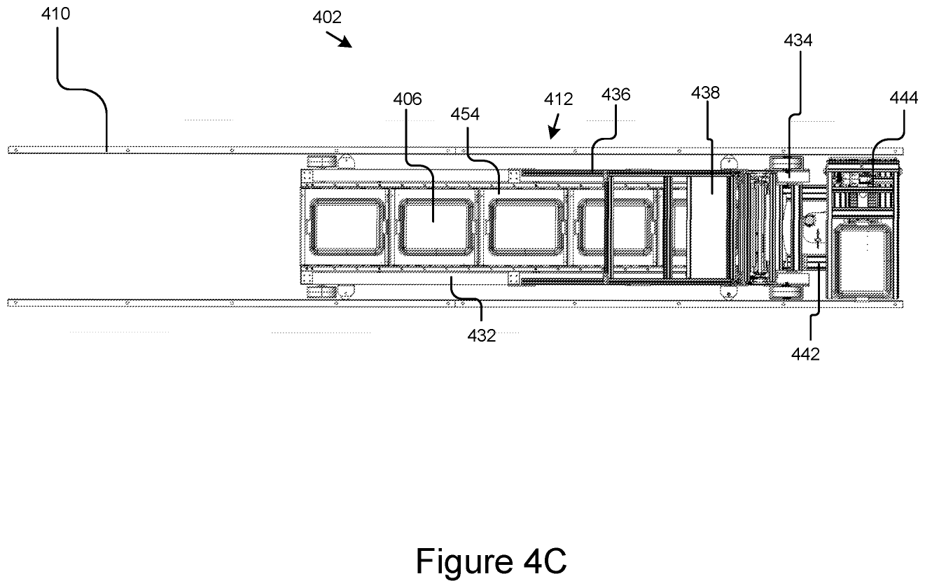

The item handling head 214 may include various mechanisms that allow it to pull items 206 from shelves 204, place items 206 on mobile conveyors 212, move items 206 between multiple mobile conveyors 212, move items 206 from a mobile conveyor 212 to an external shelf 204, or perform other operations. In some implementations, the item handling head 214 may include one or more telescoping members or arms that extend into a shelf 204 thereby allowing the item handling head 214 to retrieve or place items 206 deeper into shelves, such as into double-deep shelves, as illustrated in the example. Various example configurations of the item handling head 214 (as well as other components of the ASRS vehicle 116) are described throughout this disclosure, such as in reference to FIGS. 4A-9F.

Depending on the implementation, the ASRS vehicle 116 may be configured to navigate to a transfer point at which it transfers one or more items 206 or storage units 206 from the mobile conveyor 212 to an external device, such as an external conveyor 208, an AGV 114, a shelf of a picking station, a chute, a robotic arm, a diverter station, or other component of a fully or partially automated warehouse or fulfillment center. For instance, through rotation of one or more of the conveyors 208 and 212, or using a diverter mechanism, items 204 may be transferred to or from the mobile conveyor 212. While the transfer points for the ASRS vehicles 116a and 116b are illustrated being external to or at the end of the aisle, other locations or configurations are possible, such as midway in an aisle, at another location in a facility, etc.

In some implementations, the transfer point/location may include a docking station that receives an ASRS vehicle 116. The docking station may include a guide that assists placement, a trigger/sensor that confirms that the ASRS vehicle 116 is in place, an electrical charger, a communication port for transmitting instructions, a diverter or arm to move items 206 off the mobile conveyor(s) 212, or other devices. Each ASRS vehicle 116 may use a single transfer point or docking station or each ASRS vehicle 116 may have their own transfer point (e.g., at the end of each aisle).

In some implementations, multiple ASRS vehicles 116 may be used to retrieve items 206 from separate aisles in order to fulfill a single order. The WES 102, for instance, may coordinate their movements and task lists in order to retrieve all items 206 listed in the order, which may be transferred from the storage area by the ASRS vehicles 116 to other areas in the fulfillment center where they are picked in to shipping cartons.

Although other operations, paths, and features are possible, FIG. 2 illustrates certain operations being performed in the layout 200. For instance, a first ASRS vehicle 116a is shown navigated to an end of an aisle where its double-deep item handling head 214 is able to access two shelves deep on each side of the aisle. The item 206a is shown at a single bay or reach distance deep while item 206b is shown at a double-deep bay or each distance. The item handling head 214a may access item 206a directly, while it may have to reach past a first shelf and into a second, back shelf to access another item 206b. The improved stability of the ASRS vehicle 116a and configuration of the item handling mechanism 214a allow this increased range of motion.

In some instances, an ASRS vehicle 116 may have multiple mobile conveyors 212 or a mobile conveyor and a staging location/conveyor, which allows the ASRS vehicle 116 to shuffle a first item 206 from a front shelf 204b out of the way (e.g., on to the staging location/conveyor or second mobile conveyor 212), so the item handling head 214 can access a second item 206 on a back shelf 204a and then replace the first item on the front shelf 204b.

Once the item handling mechanism 214a removes the item 206b from its shelf 204, it may travel down the vertical rail 216a until it reaches a height of the mobile conveyor 212a at which point the item handling mechanism 214a may rotate until its telescoping members or arms face the mobile conveyor 212a. The item handling head 214 may then extend the arms to push the item 206b onto the mobile conveyor 212a. In some instances, the conveyor 212a may rotate to move the item 206b to a different location on the conveyor 212a and/or prepare for a subsequent item 206. It should be noted that other mechanisms and processes are possible, such as where the item handling head 214a rotates at a different time or performs other operations.

As illustrated in the example of FIG. 2, a second ASRS vehicle 116b may be located in a second aisle. As illustrated, the second ASRS vehicle 116b has moved toward a transfer point at the end of the second aisle. The second ASRS vehicle 116b also includes a mobile conveyor 212b, vertical support rail 216b, and item handling head 214b. As illustrated in the example, the item handling head 214b is shown rotated toward the mobile conveyor 212b and its arms are extended to place an item 206c on the mobile conveyor 212b. Additionally, two other items 206d and 206e are shown on the mobile conveyor 212b. The mobile conveyor 212b may rotate to move items 206 onto the external conveyor 208. In some instances, this movement may be assisted by external robotic arms, chutes, diverters, or other mechanisms.

In implementations where the ASRS vehicle 116 includes multiple mobile conveyors 212 (e.g., as illustrated in the example of FIG. 4A), the item handling head 214 may move items 206 between the multiple mobile conveyors 212 to shuffle items on external shelves (e.g., to allow access to a back shelf, as described elsewhere herein), to increase the number of items 206 carried by the ASRS vehicle 116 or improve the rate at which the items 206 are unloaded. For instance, where items 206 are unloaded from a top mobile conveyor 212 (e.g., where a transfer point or docking station unloads from only the top mobile conveyor 212), the item handling head 214 may move items 206 from bottom mobile conveyor 212 onto the top mobile conveyor 212, so that they may also be unloaded. When the ASRS vehicle 116 arrives at the transfer point (e.g., the unloading station, docking station, etc.), it may rotate the main conveyor 212 first to unload and also rotate the bottom conveyor 212 while using the item handling head 214 to move the items one by one from the bottom conveyor 212 to the top/main conveyor 212, which may also rotate to move the moved items 206 to unload them. In some implementations, both or all of the mobile conveyors 212 may be loaded and/or unloaded simultaneously.

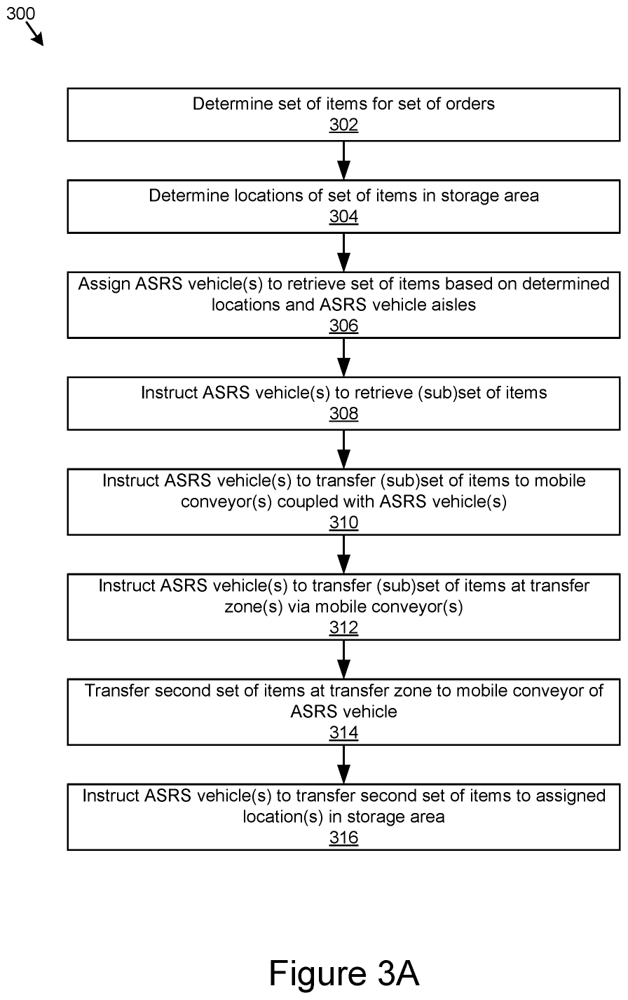

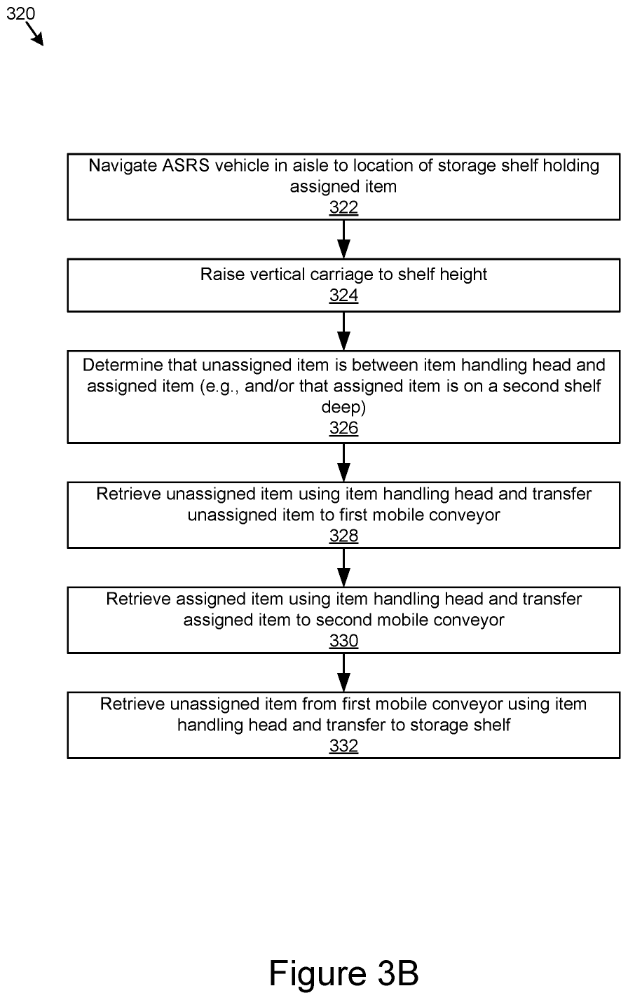

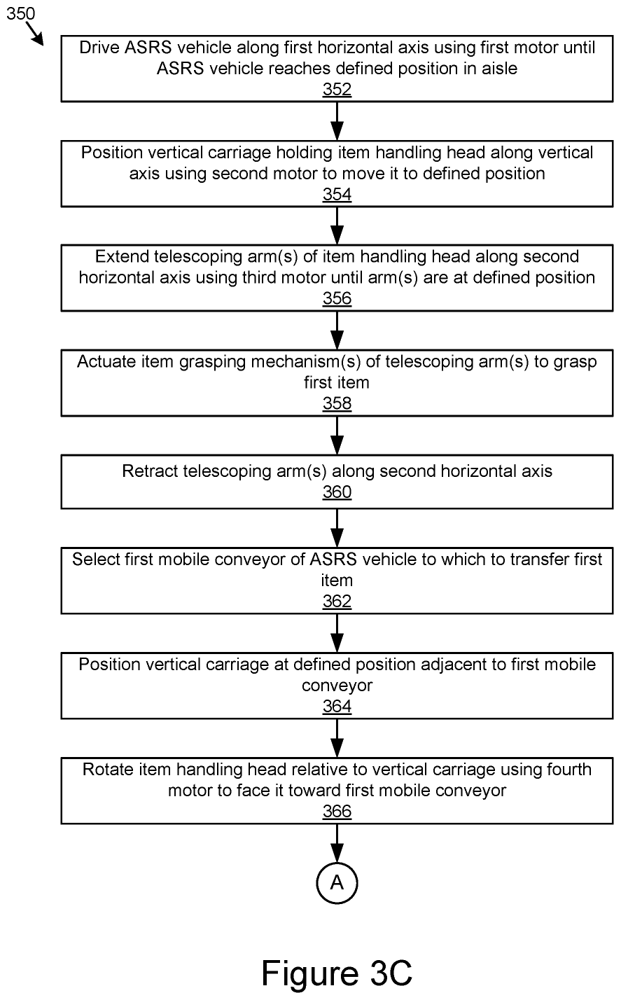

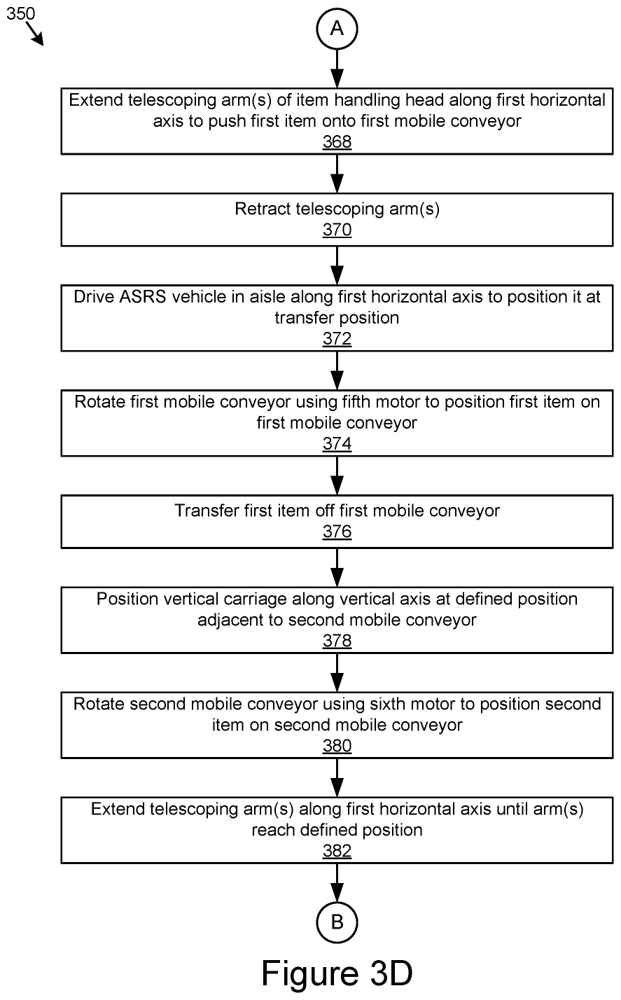

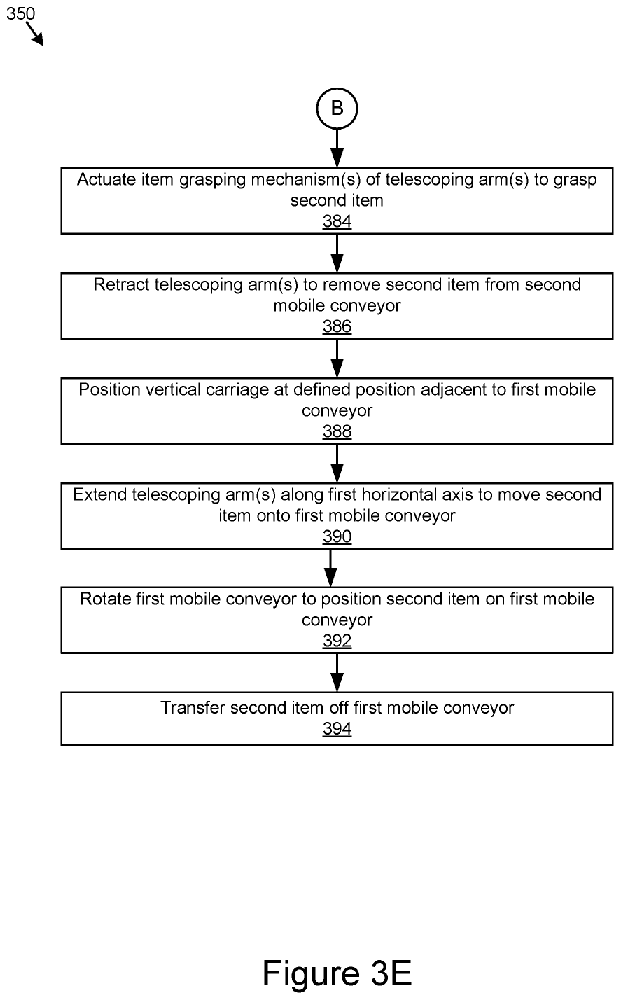

FIG. 3A-3E are flowcharts of example methods 300, 320, and 350 for automated storage and retrieval using a system, such as the ASRS system, such as those described elsewhere herein. The operations described in reference to FIGS. 3A-3E may be used with components and features described throughout this description, such as in reference to FIGS. 1, 2, and 4A-10. It should be noted that the operations of the methods 300, 320, and 350 may respectively be used interchangeably or with the other operations and features used herein. Furthermore, it should be noted that operations of the methods 300, 320, and 350 (as well as other operations of this description) may be augmented, reordered, omitted, or modified while still using technologies described in this disclosure. Similarly, the example hardware features and configurations described in this disclosure may be used with different operations, methods, contexts, etc.

It should be noted that, although the operations of the methods 300, 320, and 350 are described as being performed by the ASRS vehicle controller(s) 142 (e.g., in conjunction with the WES 102, equipment controller(s) 110, or other components), other implementations are possible, such as where another system, machine, computer, server, process, engine, etc., performs all or a portion of the operations. The WES 102, REX 118, ASRS vehicle controller(s) 142, other equipment, etc., may be communicatively coupled and may also be coupled with various sensors, motors, actuators, and devices, such as those described throughout this disclosure. For instance, an ASRS vehicle 116, AGVs 114, etc., may be controlled by a WES 102, human agent, or other device, such as those of the system 100.

Although described in reference to the ASRS vehicle controller(s) 142, some operations may be performed directly by the WES 102, by the equipment controller(s) 110, by the controller(s) 110 or 142 based on communications between these and other components, or otherwise. For example, it should be noted that some or all of the operations may be performed automatically by an equipment controller 110 or ASRS vehicle controller 142. In some implementations, operations may be controlled by a human user, such as by applying physical force via levers, by pressing buttons, or otherwise.

The operations and features described in reference to FIGS. 3A-3E, for example, may be described in additional detail throughout this disclosure, both in terms of the operations and mechanical components.

FIG. 3A is a flowchart of an example method 300 for retrieving items for one or more orders from a storage area using an ASRS vehicle 116.

At 302, the ASRS vehicle controller(s) 142 may determine a set of items for a set of orders. For instance, the WES 102 or WMS 104 may receive orders each including one or more items and may determine a time frame at which to fulfill those orders based on available resources in a fulfillment center, priority of the orders, or other criteria. The WES 102 may split the tasks for retrieving items for the orders up among various resources, such as among one or more ASRS vehicles 116 in aisles at which the items are stored. Accordingly, the WES 102 may generate a set of tasks for each of one or more ASRS vehicles 116 to retrieve or replace items or perform other operations. The WES 102 may transmit those tasks to an ASRS vehicle controller 142, as described elsewhere herein.

At 304, the ASRS vehicle controller(s) 142 may determine locations of each item 206 in the set of items in a storage area. For example, the ASRS vehicle controller(s) 142 or WES 102 may access the data store 120 to determine the locations of each item in the storage area. In some implementations, the items may be stored inside mobile storage units or totes sitting on shelves in the storage area.

At 306, the ASRS vehicle controller(s) 142 or WES 102 may assign one or more ASRS vehicles 116 to retrieve the set of items based on their determined locations (e.g., in aisles), aisles associated with the locations, and ASRS vehicles 116 associated with the aisles. For instance, the WES 102 may divide tasks in a set of orders to multiple ASRS vehicles 116 to retrieve items from their respective locations and/or balance ASRS vehicle 116 utilization (e.g., where a certain item/SKU is located in multiple aisles, or where tasks are assigned at varying time periods to balance workload).

At 308, the ASRS vehicle controller(s) 142 or WES 102 may instruct each ASRS vehicle 116 to retrieve the subset of items, for example, those items stored in an aisle associated with each respective ASRS vehicle 116. In some implementations, the WES 102, when assigning the tasks, may also transmit locations, specific operations, storage unit or tote identification codes, or other details to the ASRS vehicle controller(s) 142 to perform the assigned tasks, or the ASRS vehicle controller(s) 142 may access the data store 120 to determine information needed to perform the tasks.

At 310, the ASRS vehicle controller(s) 142 may instruct an ASRS vehicle 116 to transfer the subset of items to mobile conveyor(s) 212 coupled with the ASRS vehicle 116. For example, the WES 102 may transmit an instruction to one or more ASRS vehicle controllers 142 that cause the sensors, motors, and other components of the ASRS vehicle 116 to complete the tasks of retrieving the item from a determined or defined location. For example, the ASRS vehicle 116 may navigate down an aisle using one or more drive and one or more sensors reading navigation markers (e.g., QR codes on a floor, markers on a rail, markers on a shelf, lasers, or other guidance system components) or otherwise locate itself in the aisle. The ASRS vehicle 116 may then vertically move the item handling mechanism to a height of the assigned item, rotate toward the item, if necessary, and extend one or more grasping members or arms that remove the item from the shelf and onto the item handling head 214. The ASRS vehicle 116 may then move the item handling head 214 to a height of the mobile conveyor 212 and use it to place the item on the conveyor.

The ASRS vehicle controller(s) 142, WES 102, and/or ASRS vehicle 116 may repeat these operations to add additional items to the vehicle's mobile conveyor(s) 212, for example, by moving the items on the conveyor(s) 212.

These and other example operations and associated mechanisms are described in further detail throughout this disclosure, such as in reference to the methods in FIGS. 3B-3E.

At 312, the ASRS vehicle controller(s) 142 or WES 102 may instruct the ASRS vehicle 116 to transfer the subset of items at a transfer zone or point via the mobile conveyor(s) 212. For example, the ASRS vehicle 116 may navigate to an end of the aisle at which a transfer point is located in response to completion of a single or set of tasks where the assigned subset of items are retrieved. At the transfer point, the mobile conveyor 212 may rotate to shift the item(s) on the conveyor (e.g., on a belt or rollers), which, in some instances, may push the items off the conveyor onto another device, such as an external conveyor.

When items are stored on a second conveyor of the ASRS vehicle 116, the second conveyor may rotate and/or the item handling head 214 may retrieve items therefrom and move them to the main conveyor, which dispenses them from the ASRS vehicle 116.

At 314, the ASRS vehicle controller(s) 142 may transfer a second set of items at the transfer station onto the mobile conveyor 212 of the ASRS vehicle 116. For example, the WES 102 may determine and use the ASRS vehicle 116 to place items in the storage area, for example, after picks have been completed, to replenish storage of items (e.g., where items are stored in a mobile storage unit), or to store new items in the storage area. Accordingly, at the transfer point, items to be stored in the storage area may be transferred onto the mobile conveyor(s) 212 of the ASRS vehicle 116.

At 316, the ASRS vehicle controller(s) 142 or WES 102 may instruct an ASRS vehicle 116 to transfer the second set of items to assigned location(s) in the storage area. For example, based on the instruction(s), the ASRS vehicle 116 may navigate from the transfer point to the storage location(s) of the second set of items. The item handling head 214 may then actuate to move the item from the mobile conveyor 212 to the storage location. For instance, these operations may be performed in the reverse of the operations for retrieving items from the external shelves.

FIG. 3B is a flowchart of an example method 320 for retrieving an item, for example, from a back shelf in a double-deep shelving configuration. Beneficially, this configuration allows increased storage density thereby allowing more items and/or SKUs to be stored in a given area of a fulfillment center. As discussed in further detail elsewhere herein, the simplicity and configuration of the item handling head 214 may allow items to be retrieved and/or placed in double-deep external shelves and retrieved and/or placed on one or more mobile conveyors 212 of the ASRS vehicle 116. Additionally, or alternatively, the length and low center of gravity of the ASRS vehicle's 116 body (and/or potentially the guide rails) allows additional storage space, buffer shelves or conveyors, improved stability, increased speed, and other benefits that further allow items to be placed or retrieved quickly and potentially in a double-deep shelf configuration.

At 322, the ASRS vehicle controller(s) 142 may navigate the ASRS vehicle 116 in an aisle to a location of a storage shelf holding an assigned item, for example, based on an instruction or information received from the WES 102. The ASRS vehicle controller(s) 142 may receive sensor data that allows localization of the vehicle.

At 324, the ASRS vehicle controller(s) 142 may raise or lower a vertical carriage holding an item handling mechanism or head 214 to a shelf height of the item. For instance, the vertical carriage may position a floor or carrying surface of the item handling head 214 at the shelf height (and/or telescoping arms at or above the shelf to interact with the item). In some implementations, the height may be stored in the data store 120 and/or scanned by a sensor on the item handling head 214.

At 326, the ASRS vehicle controller(s) 142 may determine that an unassigned item is between an item handling head 214 and the assigned item (e.g., and/or that the assigned item is on a back or second deep shelf). For example, the WES 102 may determine the storage locations of items (e.g., mobile storage units) on the shelves and thereby determine that an unassigned item is currently between the item handling head 214/aisle and the assigned item on a back shelf. Additionally, or alternatively, an optical scanner of the item handling head 214 may detect an item in the way of the assigned item.

At 328, the ASRS vehicle controller(s) 142 may retrieve the unassigned item using the item handling head 214 and transfer the unassigned item to a first mobile conveyor 212 of the ASRS vehicle 116. As described in further detail below, the item handling head 214 may extend a telescoping component to or into the shelf to couple with the unassigned item, pull the unassigned item from the external shelf, rotate toward the first mobile conveyor 212, and extend the telescoping component to push the unassigned item onto the first mobile conveyor 212.

At 330, the ASRS vehicle controller(s) 142 may retrieve the assigned item using the item handling head 214 and transfer the assigned item to a second mobile conveyor 212 of the ASRS vehicle 116. The vertical carriage or item handling head 214 may move to the height of the shelf, extend the telescoping component to the assigned item (e.g., on a back shelf), pull the assigned item from the shelf, rotate toward the second conveyor, and extend the telescoping component to push the assigned item onto the second mobile conveyor 212.

At 332, the ASRS vehicle controller(s) 142 may retrieve the unassigned item from the first mobile conveyor 212 using the item handling head 214 and transfer to the external storage shelf. For instance, the item handling head 214 may reverse the operations at 328 to replace the unassigned item on the shelf. In some instances, it may replace the unassigned item on the same shelf (e.g., the front shelf) where it was previously stored while in other instances it may move the unassigned item to the back shelf and update the file associated with the item in the data store 120 to indicate its new location. Accordingly, the assigned item may more easily be returned to the location or approximate location in the aisle.

FIGS. 3C, 3D, and 3D depict a flowchart of an example method 350 for retrieving an item using an ASRS vehicle 116 with a telescoping, rotating item handling head 214, such as the example illustrated in FIG. 4A.

At 352, the ASRS vehicle controller(s) 142 may drive the ASRS vehicle 116 along a first horizontal axis using one or more first motors until the ASRS vehicle 116 reaches a defined position in the aisle. As described below, the first motor(s) may be a drive motor coupled with drive wheels directly or via a chain, belt, or gears.

At 354, the ASRS vehicle controller(s) 142 may position a vertical carriage holding an item handling mechanism or head 214 along a vertical axis using a second motor to move it to a defined position/height, such as to that of a shelf on which an assigned item is located. For example, as described below the second motor may be coupled with a belt or chain extending upward along a vertical support rail to move the vertical carriage along the vertical axis. The motor may be a servo or stepper motor that remembers its position, or the position may be determined using another sensor. In some instances, once the vertical position is reached, it may be locked in place using a lock, such as a rachet mechanism to prevent slippage in a power off or motor failure situation.

At 356, the ASRS vehicle controller(s) 142 may extend the telescoping component or arms of the item handling head 214 along a second horizontal axis (e.g., perpendicular to the direction of movement of the ASRS vehicle 116) using a third motor until the arm(s) are in a defined position (e.g., matching a depth of the item). The third motor may be coupled with the telescoping arms using various mechanisms, such as those described and illustrated elsewhere herein. The telescoping arm(s) may have one or more members at the sides, bottom, or top of the item to lift, pull, or push it.

At 358, the ASRS vehicle controller(s) 142 may actuate one or more item grasping mechanisms of the telescoping arm(s) to grasp the first item. For instance, the grasping mechanism may include rotatable fingers, a suction cup, a lifting mechanism or fork, or various other mechanisms that keep the item with the telescoping arm(s), as described elsewhere herein.

At 360, the ASRS vehicle controller(s) 142 may retract the telescoping arm(s) along the second horizontal axis to remove the item from the external shelf. For example, by rotating the third motor, the telescoping arm(s) may be retracted along with the item.

At 362, the ASRS vehicle controller(s) 142 may select a first mobile conveyor 212 of the ASRS vehicle 116 to which to transfer the first item. The first mobile conveyor 212 may be selected from a plurality of mobile conveyors 212 based on availability of locations on the conveyors, task order, randomly, or based on other criteria.

At 364, the ASRS vehicle controller(s) 142 may position the vertical carriage or item handling head 214 at a defined position or height adjacent to the selected first conveyor.

At 366, the ASRS vehicle controller(s) 142 may rotate the item handling head 214 relative to the vertical carriage or ASRS vehicle 116 using the fourth motor to face it toward the first mobile conveyor 212. For example, a fourth motor may rotate the item handling head 214 relative to the vertical carriage so that the telescoping arm(s) or other components face toward the first mobile conveyor 212. In some implementations, as the item handling head 214 rotates, it may also rotate the item that it is holding.

At 368, the ASRS vehicle controller(s) 142 may extend the telescoping arm(s) of the item handling head 214 along the first horizontal axis to push the first item onto the first mobile conveyor 212. For instance, in some implementations the first mobile conveyor 212 is in line with the movement of the ASRS vehicle 116, and the item handling head 214 rotates to allow the telescoping arms to push the item onto the first mobile conveyor 212.

At 370, the ASRS vehicle controller(s) 142 may retract the telescoping arm(s) to allow the item handling head 214 to rotate and/or move vertically.

In some instances, the first item may be positioned on a first conveyor with one or more additional items that have previously been retrieved by the ASRS vehicle 116. The ASRS vehicle 116 may also include one or more additional mobile conveyors 212 storing additional items.

At 372, the ASRS vehicle controller(s) 142 may drive the ASRS vehicle 116 along the first horizontal axis (e.g., using the first motor) to position it at a transfer point, such as at a docking station at the end of the aisle.

At 374, the ASRS vehicle controller(s) 142 may rotate the first mobile conveyor 212 using a fifth motor to position the first item on the first mobile conveyor 212. The conveyor may move the item to an end to push it off the conveyor and/or where a diverter, robotic arm, chute, or other mechanism removes the item from the conveyor. Similarly, the conveyor may rotate to move one or more other held items off the conveyor at the transfer point.

At 376, the ASRS vehicle controller(s) 142 may transfer the first item (and/or other items) off the first mobile conveyor 212, for example, by further rotating the first mobile conveyor 212 or actuating a diverter or other mechanism to move it onto an external device, such as an external conveyor that may move it to a picking station or other location in a warehouse or fulfillment center.

At 378, the ASRS vehicle controller(s) 142 may position the vertical carriage or item handling head 214 along the vertical axis at a defined position or height adjacent to a second mobile conveyor 212 of the ASRS vehicle 116. The ASRS vehicle controller(s) 142 may determine that there are additional items that were retrieved from the storage area and that are located on the second mobile conveyor 212.

At 380, the ASRS vehicle controller(s) 142 may rotate the second mobile conveyor 212 using a sixth motor coupled with the second mobile conveyor 212 to position a second item on the second mobile conveyor 212, for example, at an end proximate to the item handling head 214.

At 382, the ASRS vehicle controller(s) 142 may extend the one or more telescoping arm(s) along the first horizontal axis until the arm(s) reach a defined position at the end proximate to the item handling head 214.

At 384, the ASRS vehicle controller(s) 142 may actuate the item grasping mechanism of the telescoping arm(s) to grasp the second item, for example, as described above.

At 386, the ASRS vehicle controller(s) 142 may retract the telescoping arm(s) to remove the second item from the second mobile conveyor 212, for example, by pulling it onto the item handling mechanism.

At 388, the ASRS vehicle controller(s) 142 may position the vertical carriage or item handling head 214 at a defined position or height adjacent to the first mobile conveyor 212.

At 390, the ASRS vehicle controller(s) 142 may extend the telescoping arm(s) along the first horizontal axis to move the second item onto the first mobile conveyor 212. The ASRS vehicle controller(s) 142 may deactivate the grasping mechanism and, in some instances, retract the telescoping arm(s).

At 392, the ASRS vehicle controller(s) 142 may rotate the first mobile conveyor 212 to position the second item on the first mobile conveyor 212, for example, at an end at the transfer point.

At 394, the ASRS vehicle controller(s) 142 may transfer the second item off the first mobile conveyor 212, for example, as described above. Additionally, where other items are on the first or second mobile conveyors 212, they may accordingly be positioned by the conveyor(s) and/or item handling head 214 and transferred off the ASRS vehicle 116.

As discussed above, the operations of the methods described in reference to FIGS. 3B-3E may be reversed to place items on storage shelves.

FIGS. 4A-9F illustrate various example implementations of an ASRS vehicle 402 and/or example components, which may be used, for instance, in conjunction or in alternative with the other features and operations described herein. The example ASRS vehicle 402 may represent example implementations of the ASRS vehicle 116 (and/or its components) described above, although other configurations are possible and contemplated. Additionally, it should be noted that its features may be used separately or together with each other and others described herein. Similarly, they may be used with or without the operations described herein.

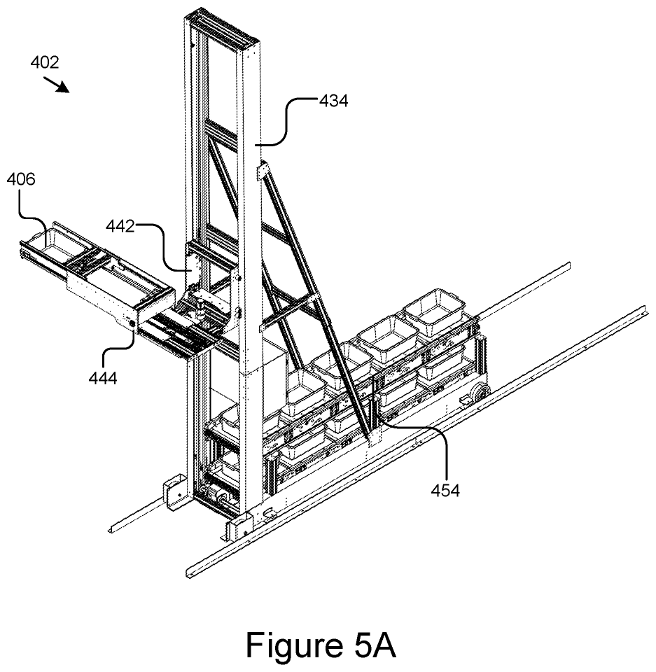

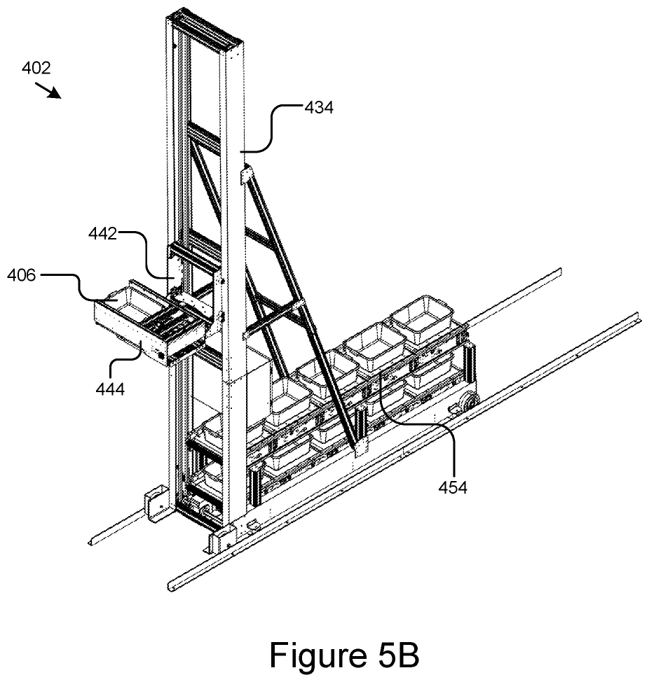

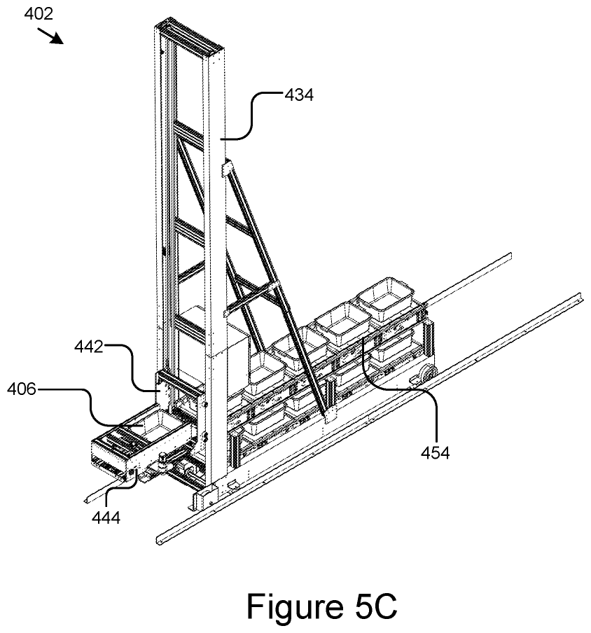

FIGS. 4A-4C illustrate various views of an example ASRS vehicle 402. Example features and components of the ASRS vehicle 402 are described in reference to FIGS. 5A-9F below. FIG. 4A illustrates a perspective view of the example ASRS vehicle 402, FIG. 4B illustrates a right-side view of the example ASRS vehicle 402, and FIG. 4C illustrates a top-down view of the example ASRS vehicle 402. Although certain implementations and configurations are shown and described, it should be noted that they are provided by way of example and that others are possible and contemplated herein.

Although other implementations are possible, an ASRS vehicle 402 may include a cart or body 412 that moves along one or more guide rails 410, which provide guidance, support, rigidity, power, communication, or other services to the ASRS vehicle 402. A vertical mast 416 may be coupled with the body 432 (e.g., at an end thereof) and extend upward therefrom. An item handling head 414 may include a vertical carriage 442 and an item handling mechanism 444, for instance. A vertical carriage 442 may be movably coupled with the vertical support rail(s) 434 to move upward or downward along the vertical rail(s) 434. The vertical carriage 442 may lift and lower an item handling mechanism 444 to access external shelves of various heights and/or mobile conveyors at various heights. In some implementations, power, communications, controller (e.g., an ASRS vehicle controller 142), or other components may be mounted to the ASRS vehicle 402, for example, in a box 438 on the mast 416.

The ASRS body 412 may include drive wheels that contact a floor or external guide rails 410 and/or guide wheels that align the ASRS body 412 along the guide rails 410. The ASRS body 412 may include a frame 432 that provides structure to its motors, wheels, the mast 416, and one or more mobile conveyors 452 and 454, which may be stacked vertically, positioned at the same level next to one another, or otherwise.

The mast 416 may include one or more vertical support rails 434, which may include side frames, tracks, a chain or belt path, pulleys, or other components. The ASRS vehicle 402 may include one or more buttresses 436 that stabilize the vertical support rails 434.

In the illustrated example, the ASRS body 412 may provide support for a bottom conveyor 452 and a top conveyor 454. Depending on the implementation, each of these conveyors may couple with internal or external motors to allow them to rotate and position items thereon. In some instances, both conveyors may transfer items therefrom or thereto simultaneously or only a single conveyor (e.g., the top conveyor 454) may transfer items at a transfer point while the second conveyor (e.g., the bottom conveyor 452) may transfer items to the first conveyor using the item handling mechanism 444. As illustrated numerous items 406, such as mobile storage units or totes may be carried on the conveyors 452 and 454.

The length of the body 412, its low center of gravity, and its other features improve its stability so that a tall mast 416 may be used, the ASRS vehicle 402 may move quickly, and a double-deep item handling mechanism 444 may be used.

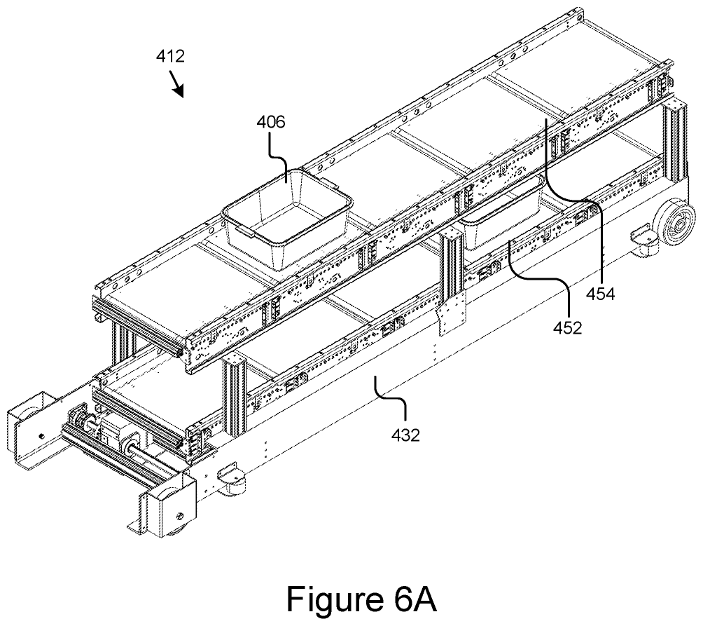

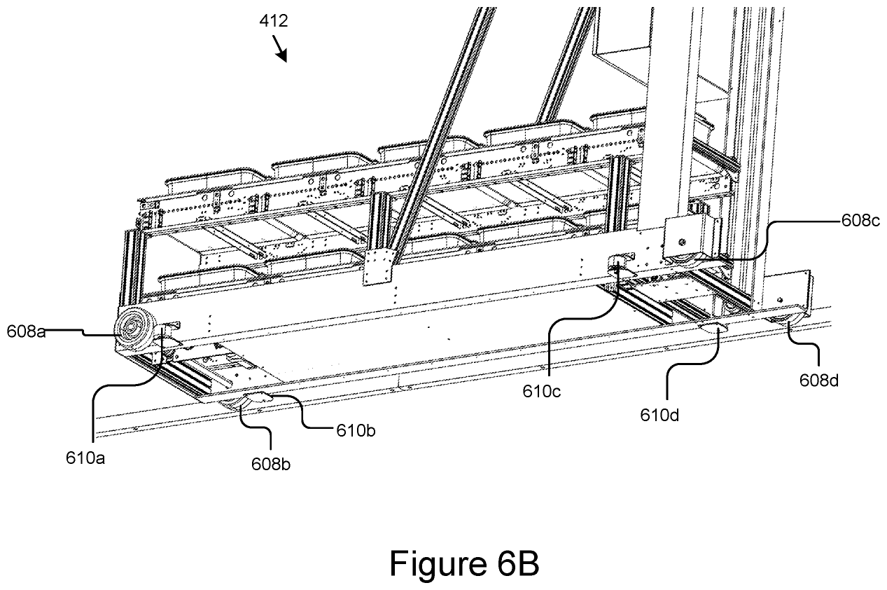

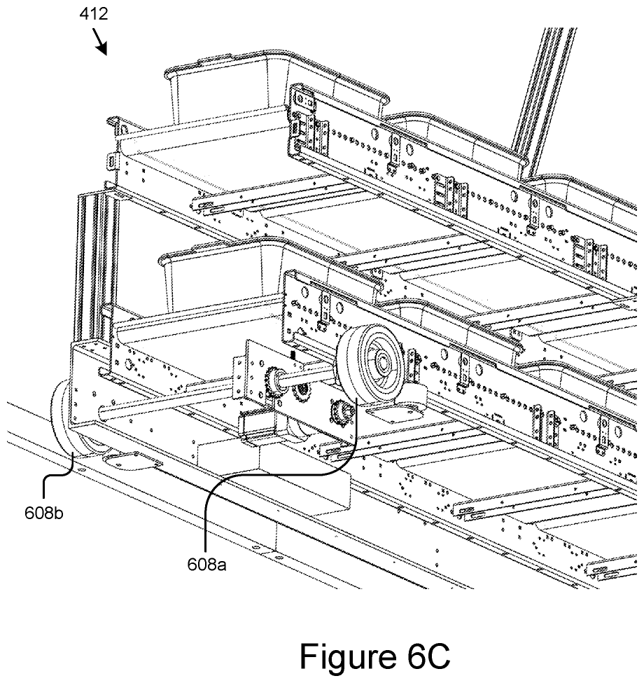

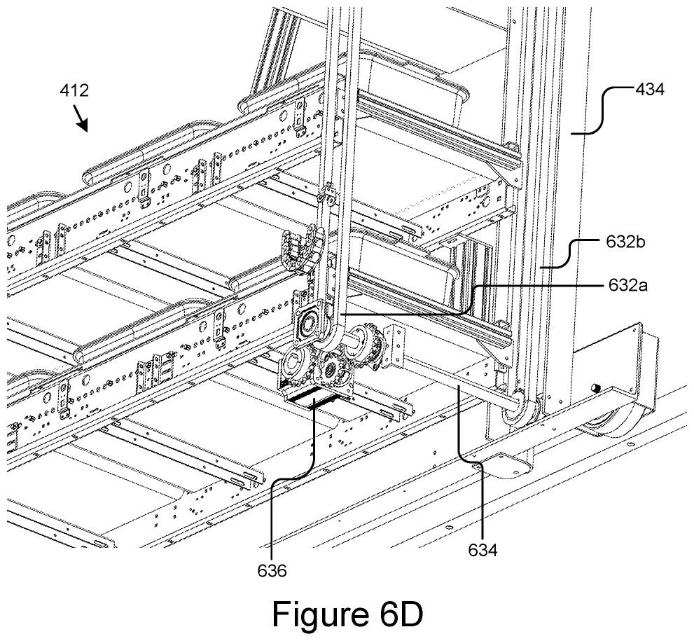

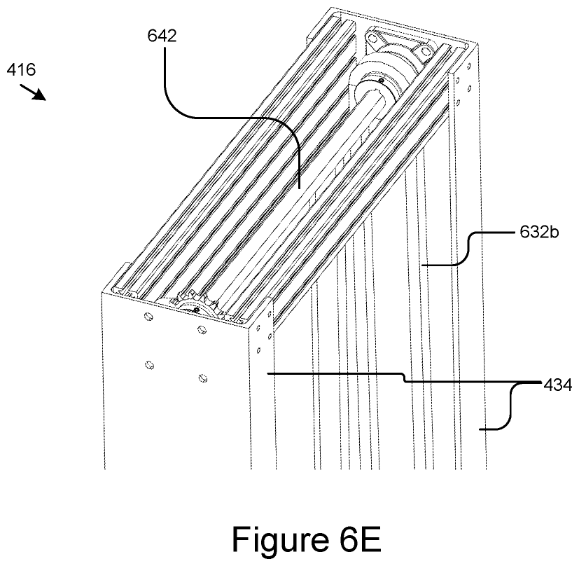

Additional details of the ASRS body 412 are described in further detail elsewhere herein, such as in reference to FIGS. 6A-6E.

The item handling mechanism 444 may be carried on the vertical carriage 442 along the vertical support rail(s) 434. For instance, a motor may be located in the ASRS body 412 and coupled with belts or chains (e.g., a chain on each side or support rail and coupled together using a driveshaft) extending up the mast 416, over a top pulley or sprocket, and back down to the motor-drive gear. The vertical carriage may be coupled with the belt/chain. This configuration allows a heavy motor to remain low while moving the vertical carriage 442. Accordingly, an ASRS vehicle controller 142 may instruct the mast motor to move the vertical carriage 442 to a defined height.

An item handling mechanism 444 may be carried by the vertical carriage 442. Although various configurations are possible and contemplated, it may be configured to rotate in place and/or extend in one or more directions. For instance, the item handling mechanism 444 may extend horizontally perpendicular (and/or parallel) to the movement of the ASRS vehicle 402 to access external shelves. The item handling head, depending on the implementation, may also be configured to rotate, which allows it to extend toward the conveyors 452 and 454 to place or retrieve items.

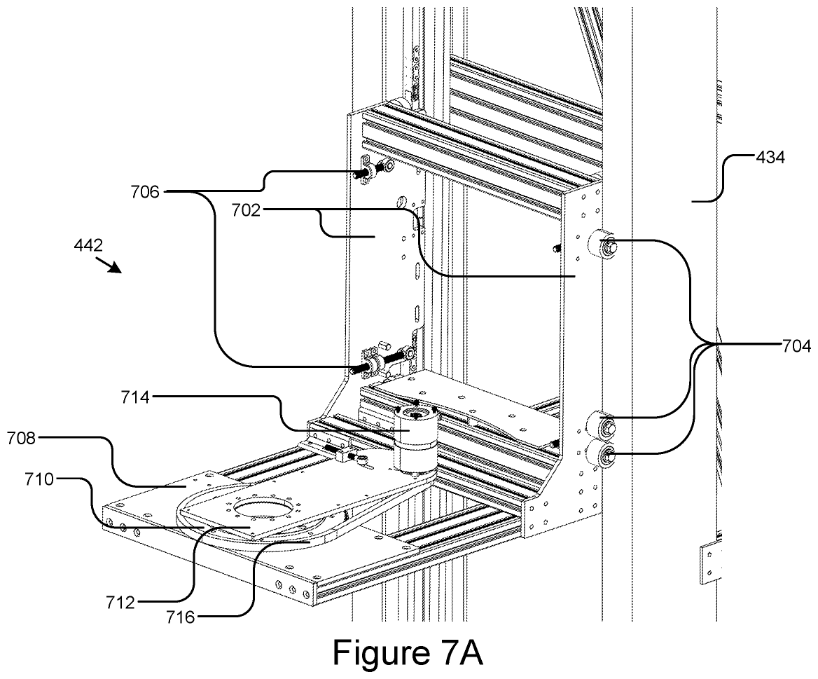

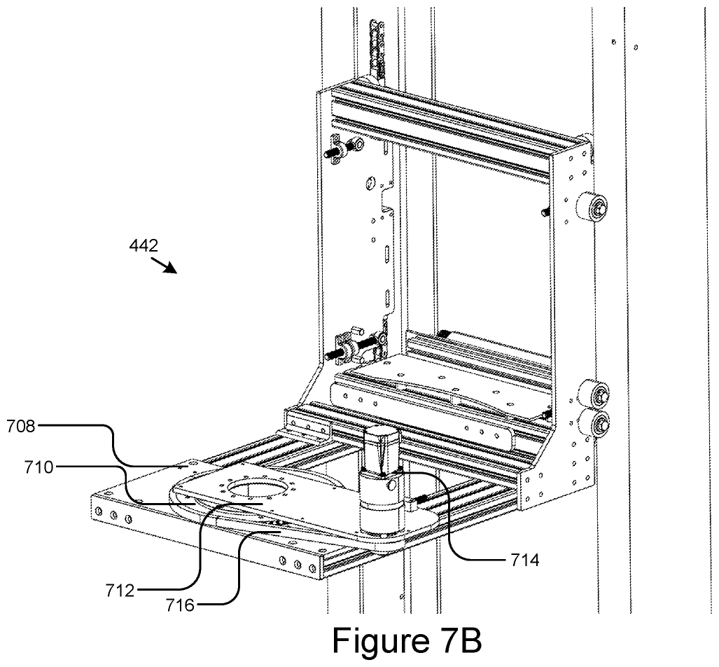

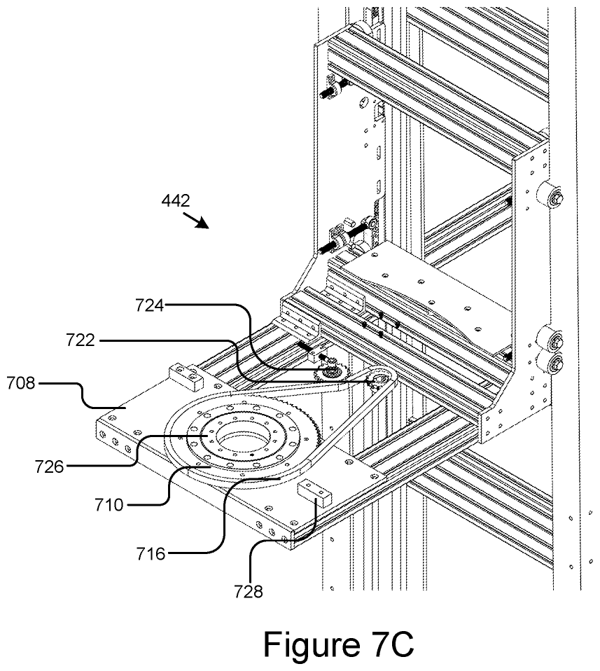

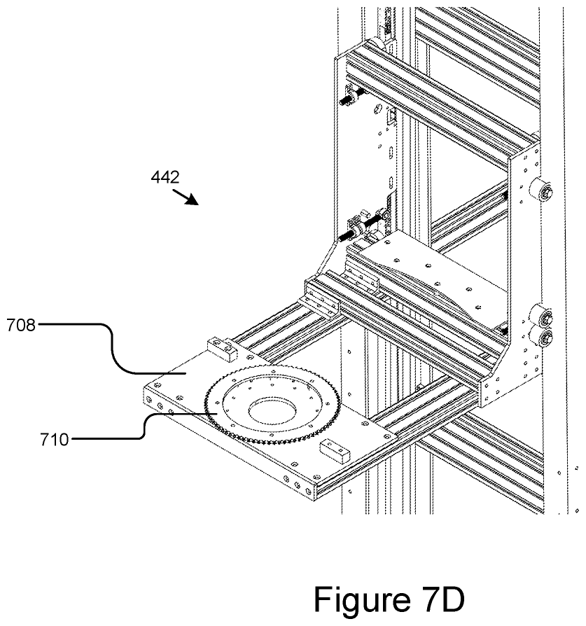

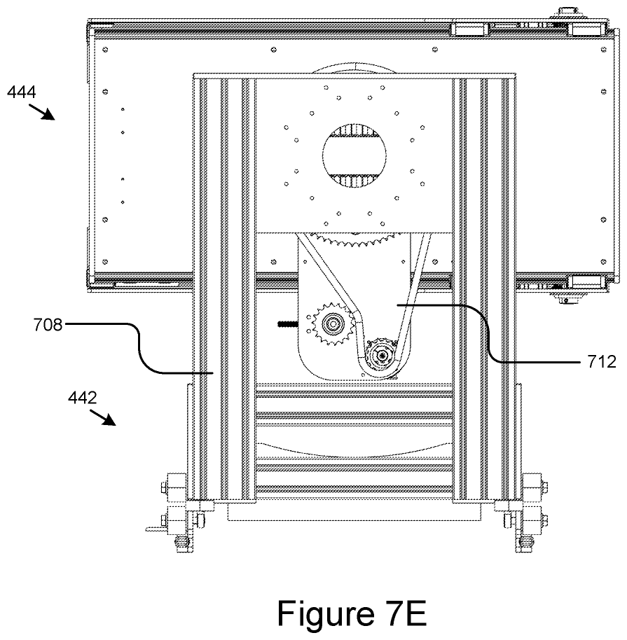

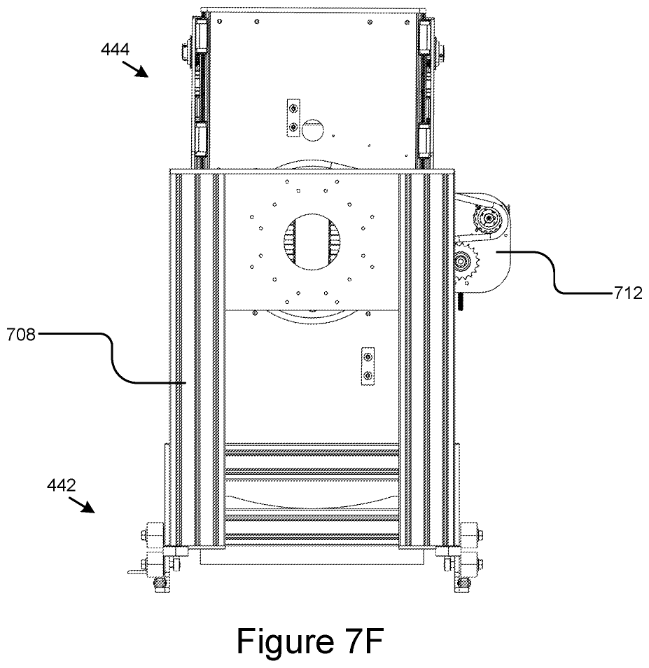

Example configurations of the item handling mechanism 444 and support carriage are described in further detail below, for example, in reference to FIGS. 7A-9F.

Although other configurations are possible, illustrated example configurations are provided. In some figures, certain elements have been omitted from illustration to improve clarity. The features described in reference to the various figures herein may be omitted, changed, interchanged, or augmented without departing from the technology. For instance, aspects of some example implementations may be used with other implementations.

FIGS. 5A-5C illustrate perspective views of an example ASRS vehicle 402 with its vertical carriage 442 and item handling mechanism 444 in different positions. It should be noted that these views are provided by way of example and that other operations and positions are possible and contemplated. Additionally, example mechanisms for these movements are described in further detail below, although others are possible and contemplated herein.

FIG. 5A illustrates the vertical carriage 442 in a partially raised position, as if it were at the elevation of an external storage shelf (not shown) to retrieve an item 406 therefrom. The item handling mechanism 444 is shown in a fully extended position, such as where it would reach a back shelf in a double-deep shelving arrangement. The item handling mechanism 444 may include one or more structures, which are referred to herein as extendable or telescoping members or arms, and that extend outward from the vertical carriage 442 to interact with items on an external shelf or internal mobile conveyor (e.g., 454). It should be noted that although the extendable structure is described as a member or arm, it may take various shapes or configurations. Example implementations of the item handling head are described in further detail elsewhere herein, for example, in reference to FIGS. 7A-9F. For example, pulleys, belts, and motors may be connected with extendible portions of the item handling head to cause some or all of it to extend or retract, as described elsewhere herein. Additionally, other implementations, such as robotic arms, multi-directional sliding platforms, or other devices are possible and contemplated.

FIG. 5B illustrates the item handling mechanism 444 in a retracted position and holding an item 406, for example, where the item handling mechanism 444 has retracted from the extended position shown in FIG. 5A.

FIG. 5C illustrates the vertical carriage 442 moved vertically downward to be at a height matching the mobile conveyor 454, for example, to place an item on the conveyor 454. The item handling mechanism 444 is also shown rotated toward the mobile conveyor 454 to place the item 406 thereon. The vertical carriage 442 and item handling mechanism 444 may repeat this process to add items to mobile conveyors. In some cases, where the mobile conveyor(s) 454 have no remaining capacity, the item handling mechanism 444 may hold an item 406 during transportation and may transfer the item 406 onto the conveyor 454, for example at a transfer point.

FIGS. 6A-6E illustrate various views of an ASRS body 412 and other portions of an ASRS vehicle 402. For example, the ASRS body may be a lower portion of an ASRS vehicle 402.

As illustrated in FIG. 6A, an ASRS body 412 may include one or more frame members 432 that support and transport conveyors 452 and 454, which may, in turn, hold one or more items 406. The ASRS body 412 may have a generally rectangular shape in which the mobile conveyors 452 and 454 extend away from an end of the body 412 where the item handling mechanism 444 (not shown in FIG. 6A) is mounted. Depending on the implementation, the transfer point may be at an opposing end to the item handling mechanism 444.

As illustrated, an ASRS body 412 may include a frame and/or body that provides structure to the ASRS body 412. The frame may be constructed of aluminum extrusions, stamped plates, or otherwise.

FIG. 6B illustrates the example ASRS body 412 from a bottom-up perspective view. As shown in the example, the ASRS body 412 may include four wheels 608a, 608b, 608c, and 608d that provide vertical support to the body 412, although other quantities and positions are possible. Depending on the implementation, one or more of the wheels 608 may be a drive wheel coupled with a motor that causes the ASRS body 412 to move. For instance, wheels 608a and 608b are illustrated being coupled with a driveshaft and drive motor while wheels 608c and 608d are free moving.

For instance, FIG. 6C shows a cut away bottom perspective view of the ASRS body 412 where the drive wheels 608a and 608b are coupled together via a driveshaft, which is in turn coupled with a geared motor via a gear and chain (not shown).

Returning to FIG. 6B, the ASRS body 412 may also include four guide wheels 610a, 610b, 610c, and 610d, which contact shelves or a guide rail to keep the ASRS body 412 aligned as it moves, although other implementations are possible. The guide wheels 610 may be mounted horizontally to contact sides of guide rails mounted to a floor. The guide rails may be bolted directly to a floor of the fulfillment center and/or may include locating markers that may be scanned by the ASRS vehicle 402, although many other types of locating mechanisms are possible.

In some implementations, the ASRS body 412 may include brushes that contact the power rail(s) (which may be combined or separate from the guide rails, etc.) and provide power to the ASRS vehicle's 402 components. It should be noted that other means of providing power are possible, such as where the ASRS vehicle 402 includes a rechargeable battery or where it is continuously coupled with an external power source using wire(s) (e.g., in a wire chase and/or drag chain).

FIG. 6D illustrates a bottom-up perspective view of a portion of an ASRS vehicle 402. In the depicted illustration, a portion of the ASRS body 412, including frame members are omitted to expose certain components. For example, as illustrated, a first and second belt (or chain, etc.) 632a and 632b extend upward into vertical support rails (only one rail is shown) 434. The belts 632 may wrap around sprockets or gears, which are coupled together via a driveshaft 634. Another gear on the driveshaft 634 may couple the driveshaft 634 to a motor 636 via a chain (not shown), and/or one or more other gears.

The vertical carriage 442 (not shown in FIG. 6D) may be coupled with the belts 632a and 632b, so that when the belt(s) 632 move upward or downward, the vertical carriage 442 also move upward or downward. For instance, the motor 636 is mounted low inside the ASRS body 412 to lower the center of gravity while the belt position and geared linkage allows a full vertical range of motion of the vertical carriage 442 (e.g., where it may access a low shelf or conveyor).

In some implementations, a locking mechanism may also be included on the motor 636, driveshaft 634, belt(s) 632, gears, a top pulley or sprocket, vertical carriage 442 to prevent the vertical carriage 442 from falling if power is lost to the motor 636. For instance, the brake may include a ratcheting mechanism, automatically actuated friction brake, automatically inserted locking pin, motor shorting for increased resistance, or other mechanism to prevent the vertical carriage 442 from falling if there is a failure or electrical power is lost.

FIG. 6E illustrates a top perspective view of a mast 416 where a top driveshaft 642 extends between vertical support rails 434. The top driveshaft 642 may couple a gear, sprocket, or pulley on each end to keep belts 632 (only one belt 632b is visible in FIG. 6E) in alignment and allow them to remain in a loop to facilitate vertical carriage 442 movement. Although not shown in FIG. 6E, in some implementations, the vertical support rail(s) 434 may include a wire chase or drag chain that provides power to motors on the vertical carriage 442 and/or item handling mechanism 444.

FIGS. 7A-7F illustrate various views and configurations of a vertical carriage 442. The vertical carriage 442 may carry an item handling mechanism 444 vertically along one or more vertical support rails 434. The vertical carriage 442 may be coupled with a chain (and/or belt, etc.), as described above, which causes it to move vertically, although other mechanisms, such as drive wheels, pneumatics, linear actuators, or other mechanisms may raise or lower the vertical carriage 442. It should also be noted that, depending on the implementation, the vertical carriage 442 may be integrated with or may be separate from the item handling mechanism 444.

In the illustrated example, the vertical carriage 442 may include frame member(s) 702 that extend vertically partially along the vertical support rail(s) 434 to provide rigidity and support to the vertical carriage 442. Frame member(s) 702 may be held apart by other structures or cross frames. In some implementations, the frame member(s) 702 may include or couple with a track and/or various wheels or bearings 704, which may be on the front, inside, back, and/or outside of the vertical support rail(s) 434. For instance, the bearings 704 keep the vertical carriage 442 aligned with the vertical support rail(s) 434 while also allowing it to easily slide upward or downward. The bearings 704 may be spaced apart (e.g., vertically) to prevent the frame member(s) 702 from binding on the vertical support rail(s) 434. The bearings 704 may have various orientations, for example, some bearings 704 may be on an inside of the vertical support rail(s) 434 (or track thereof) perpendicular to those shown in FIG. 7A.

In some implementations, the vertical carriage 442 may include one or more adjustment mechanisms 706 that allows it to be tightened, loosened, its angle to be moved, or other adjustments to be made.

The vertical carriage 442 may include a platform 708 that extends horizontally from the frame member(s) 702 and away from the vertical support rail(s) 434. The platform 708 may include frames, mounting plates, reinforcing structures, and other devices that allow it to securely support an item handling mechanism 444. For example, the frame member(s) 702 may be shaped to extend to the platform 708 to buttress its strength. Other mechanisms, such as wires, buttresses, etc., may also be used to increase strength depending on loads being lifted in a particular application.

FIG. 7D illustrates the platform 708 of a vertical carriage 442. As shown, a large gear 710 or sprocket may be mounted horizontally to the platform 708 with a recess or groove in the center, which may hold an item handling mechanism 444 (not shown) and allow it to turn about an axis formed by the center of the gear 710. The gear 710 may include radially or axially oriented teeth that interact with one or more external mechanisms to allow the item handling mechanism 444 to rotate relative to the platform 708. In the depicted example, the gear 710 is rigidly connected (e.g., via bolts or other fasteners) with the platform 708 so that the gear does not rotate relative to the platform. In other implementations, the gear may rotate to cause the item handling mechanism 444 to rotate.

Returning to FIG. 7A, an example rotatable platform 712 is shown with a pivot point at the center of the gear 710. The rotatable platform 712 may form a bottom or may be coupled with a bottom surface of the item handling mechanism 444, as shown elsewhere herein, but it is shown in FIG. 7A without the item handling mechanism 444 for illustration purposes. In the depicted example, a vertically mounted motor 714 may be mounted to the rotatable platform 712, although it may be mounted in various positions or orientations. The motor 714 may include a gear that interacts with a belt 716 or chain extending around the gear 710, so that when the motor 714 rotates the gear, the rotatable platform 712 rotates about the gear 710 and relative to the platform 708. In this configuration, the belt 716 may remain stationary on some of the teeth of the gear 710. For instance, the platform 708 and/or 714 may include protrusions or stops that prevent the platform 712 from rotating more than a defined angle (e.g., 90, 180, or 270 degrees), although other implementations are possible.

In some implementations, the gear of the motor 714 may interact directly with the gear 710 or the motor 714 may be mounted horizontally or may be coupled instead with the platform 708.

In some implementations, the rotatable platform 712 extends away from an axis of rotation and the motor 714 interacts with the gear 710 via a belt 716, which allows the motor 714 to be easily accessible and mounted at a side of the item handling mechanism 444 while also avoiding potentially contacting the platform 708 or other components of the vertical carriage 442 or item handling mechanism 444. Thus, the vertical range of motion and horizontal range of motion are improved by this configuration.

FIG. 7B illustrates another view of the rotatable platform 712 mounted to the platform 708 via the center of the gear 710. As illustrated, the motor 714 has rotated the belt 716, which has caused the rotatable platform 712 to rotate ninety degrees, which would, correspondingly, rotate other components of the item handling mechanism 444, as described elsewhere herein.

FIG. 7C illustrates the belt 716 extending around the gear 710 with the rotatable platform 712 omitted. As shown, the belt 716 may loop around a second gear 722 and along a tensioning gear/pulley 724 that provides tension to the belt 716. The second gear 722 may be coupled with the motor 714 (not shown in FIG. 7C) to interact with the belt 716. The tensioning pulley 724 may be adjustable and/or spring loaded to increase or decrease tension in the belt 716.

FIG. 7C also illustrates a center portion 726 of an item handling mechanism 444, which may extend into the center of the gear 710, so that the item handling mechanism 444 may rotate about the gear 710. The center portion 726 may be bolted to the rotatable platform 712, for instance, and may include ball, liquid, or other bearings that decrease friction during rotation.

The platform 708 in FIG. 7C also illustrates one or more stops 728 protruding from the platform 708, which may interact with corresponding structures on the item handling mechanism 444 to prevent it from rotating beyond a defined point and/or locate the head 444 rotationally, although other mechanisms are possible and contemplated, such as different stops, sensors/triggers, etc.

FIGS. 7E and 7F illustrate bottom-up views of the platform 708 of an example vertical carriage 442 coupled with an example item handling mechanism 444. FIG. 7E illustrates the item handling mechanism 444 in a first orientation (e.g., where it would extend perpendicularly to the direction of motion of the ASRS vehicle 402) and FIG. 7F illustrates the item handling mechanism 444 in a second orientation (e.g., where it would extend parallel with the direction of motion of the ASRS vehicle 402). As shown, the rotatable platform 712 may rotate relative to the platform 708 of the vertical carriage 442.

In some implementations, as depicted in FIG. 7F, the item handling mechanism 444 may be oriented, so that it may extend (e.g., via extendable members or arms thereof) between the vertical support rails 434 to access a mobile conveyor (not shown).

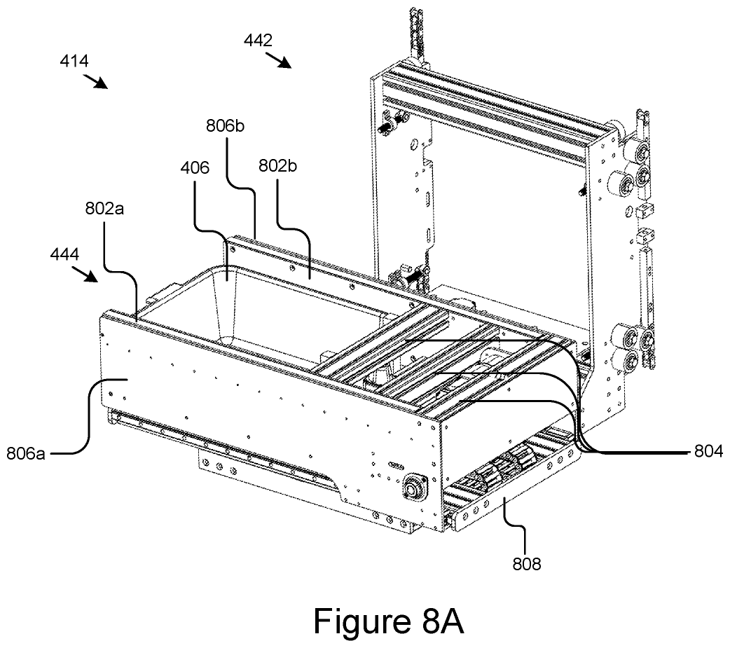

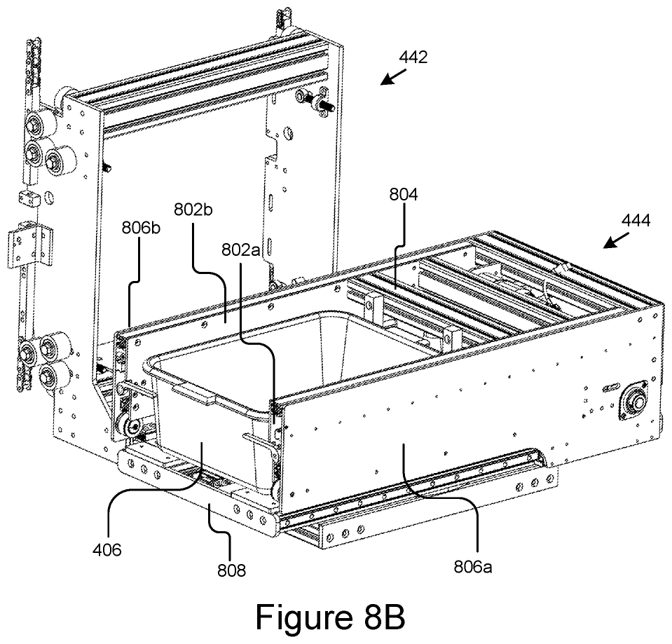

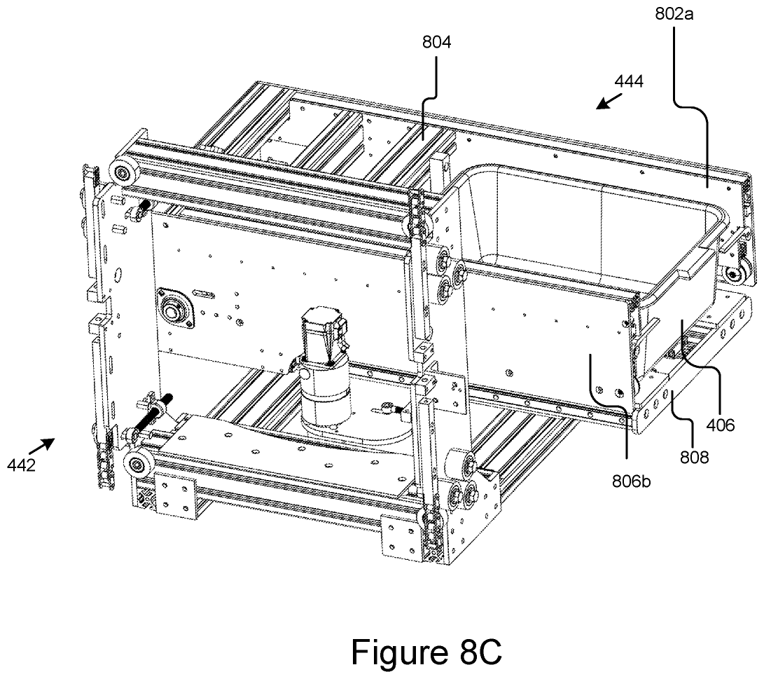

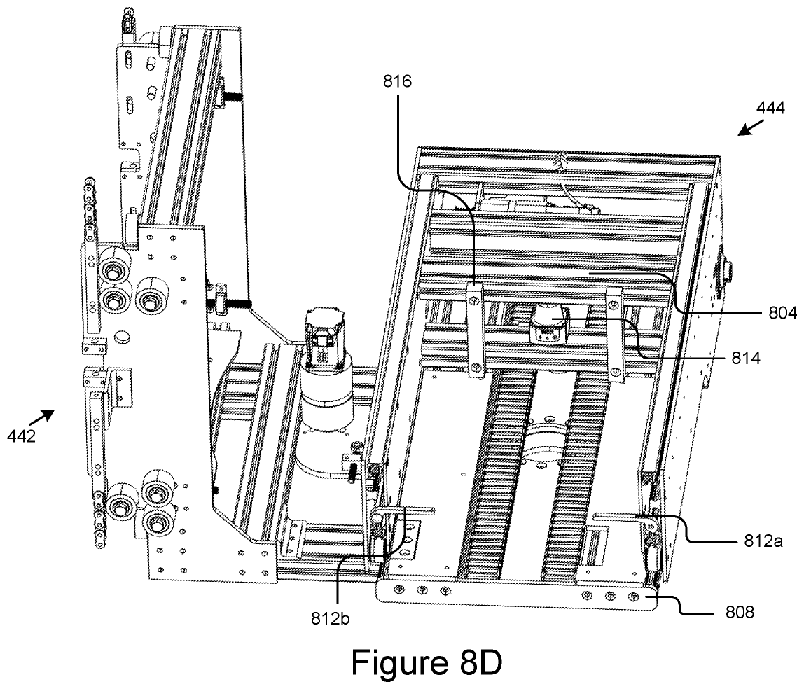

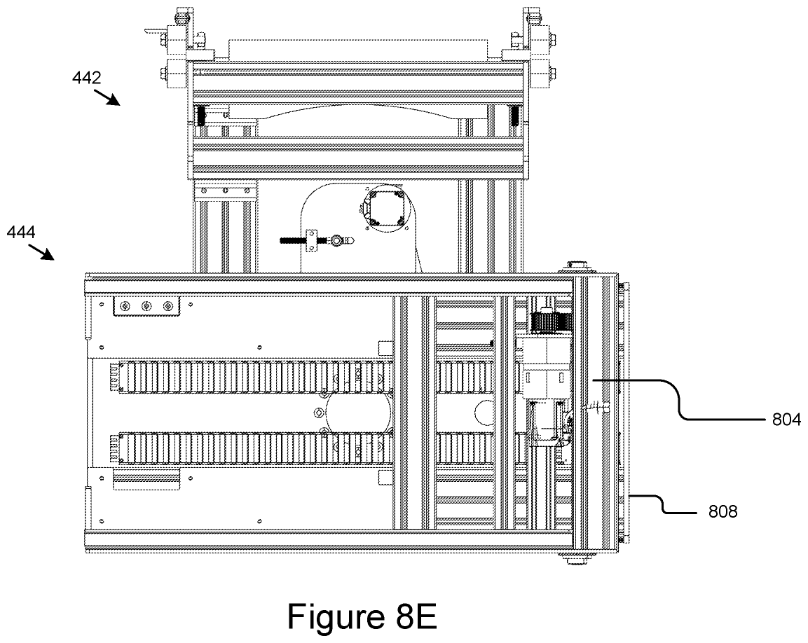

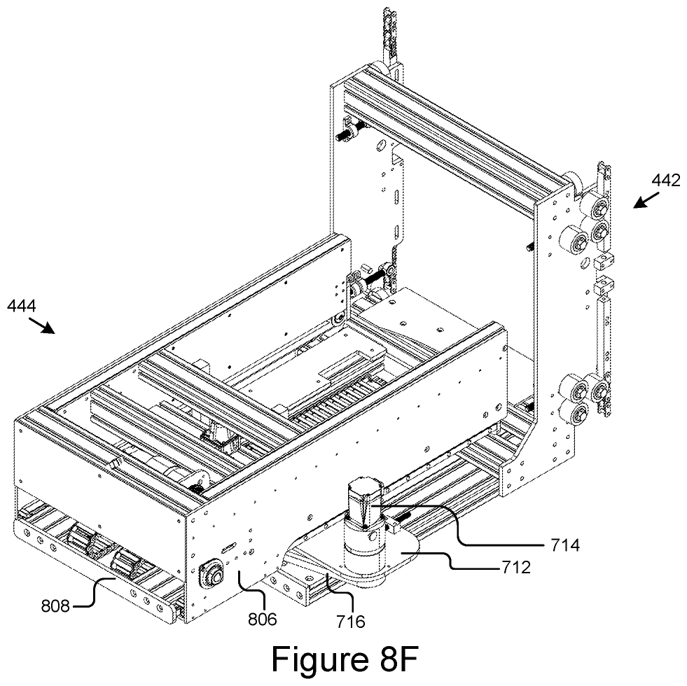

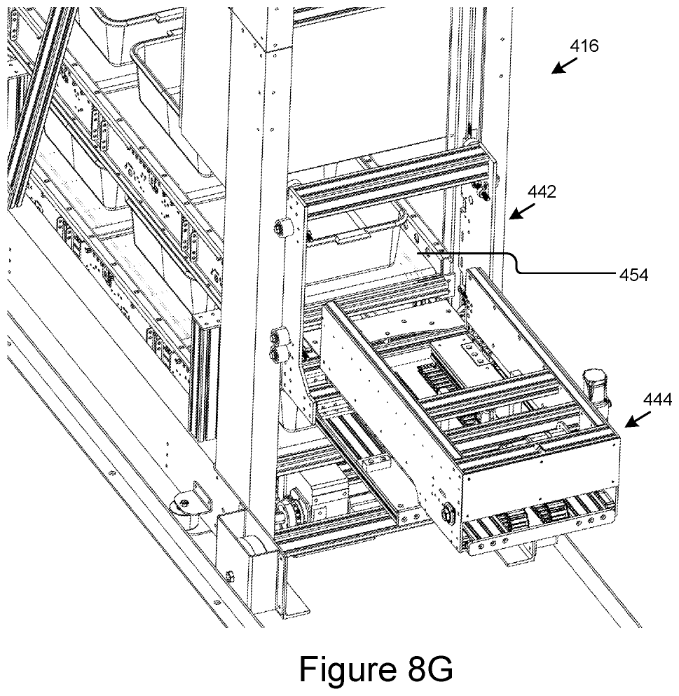

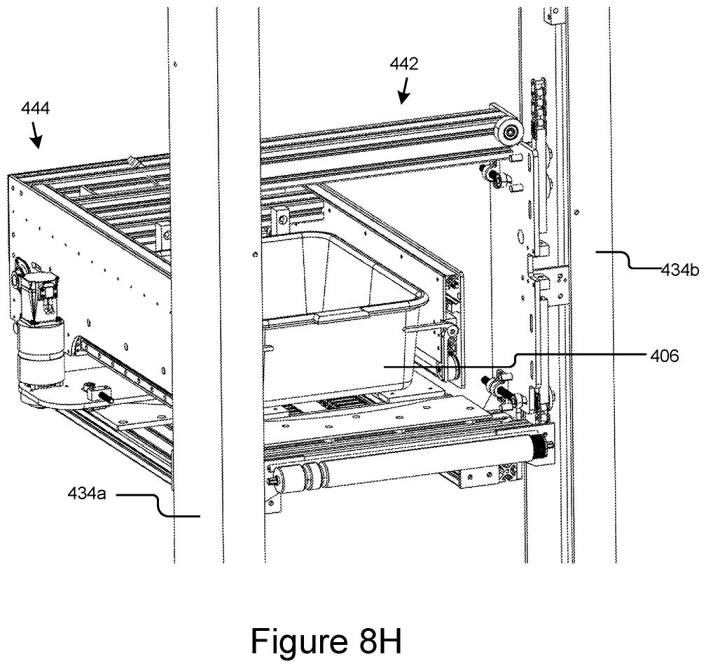

FIGS. 8A-8H illustrate various views of an example implementation of an item handling mechanism 444, which may be coupled with a vertical carriage 442.

FIG. 8A illustrates a right (when facing an item handling mechanism 444) perspective view of an example implementation of an item handling head 414, such as an item handling mechanism 444 held by a vertical carriage 442 and holding an item 406, which may be a tote or mobile storage unit. FIG. 8B illustrates a left perspective view of an example implementation of an item handling mechanism 444 held by a vertical carriage 442 and holding an item 406. FIG. 8C illustrates a back perspective view of an example implementation of an item handling mechanism 444 held by a vertical carriage 442 and holding an item 406.

FIGS. 8A, 8B, and 8C illustrate various views of an item handling mechanism 444 and a vertical carriage 442 in a first orientation, for example, where the item handling mechanism 444 is rotated to extend into an external shelf to the side of an ASRS vehicle 402 (not shown). FIG. 8D also illustrates a side view of an item handling mechanism 444 and vertical carriage 442 and FIG. 8E illustrates a top-down view in this sideways orientation, but the item handling mechanism 444 is not holding an item.

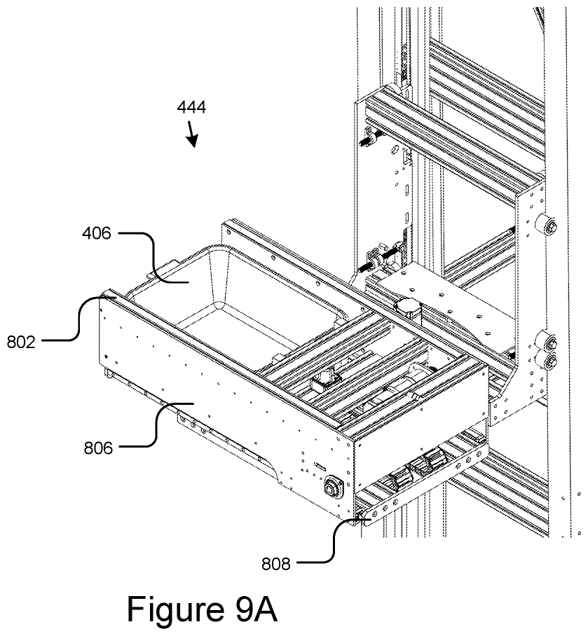

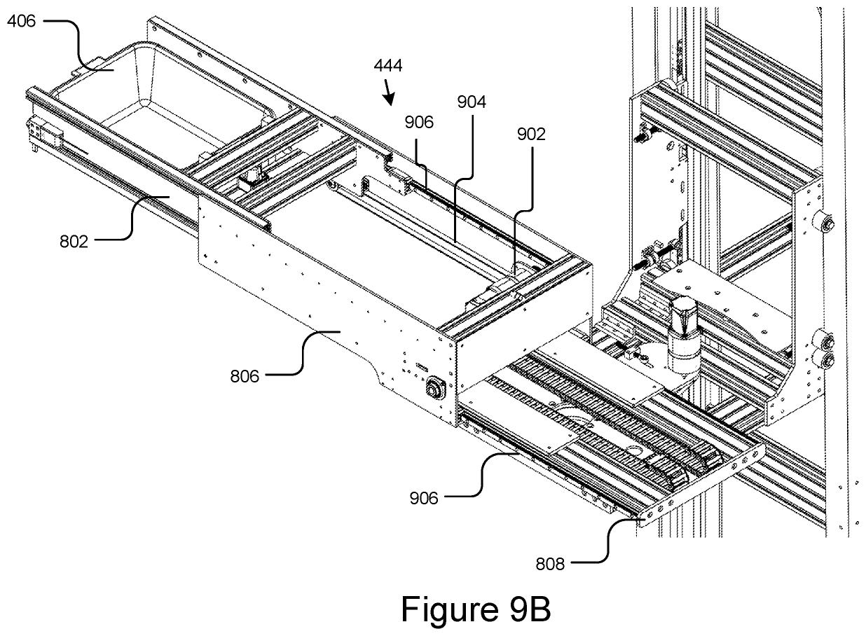

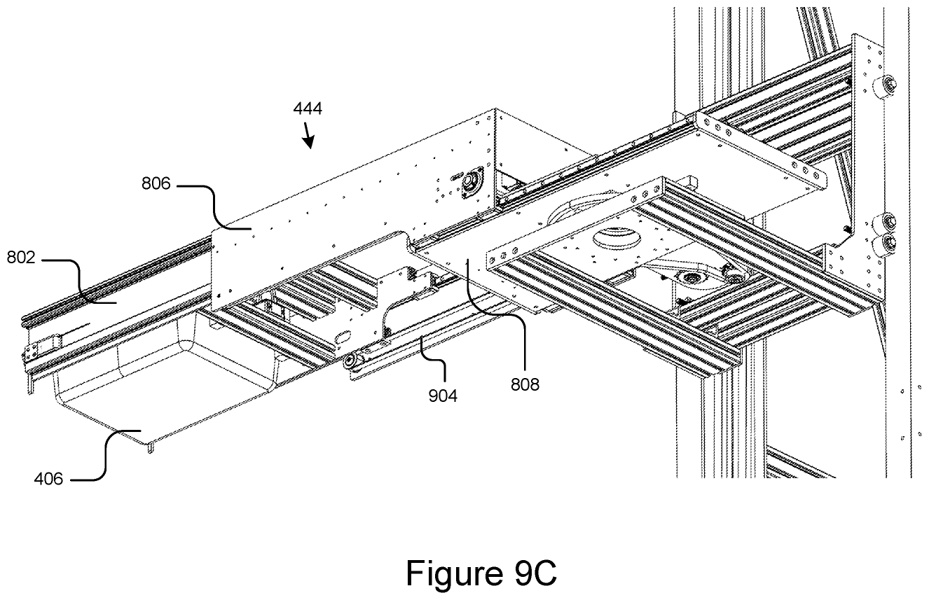

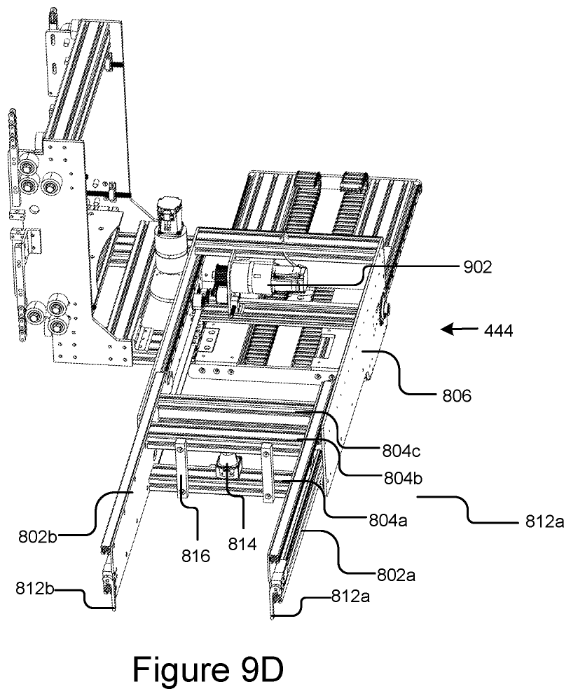

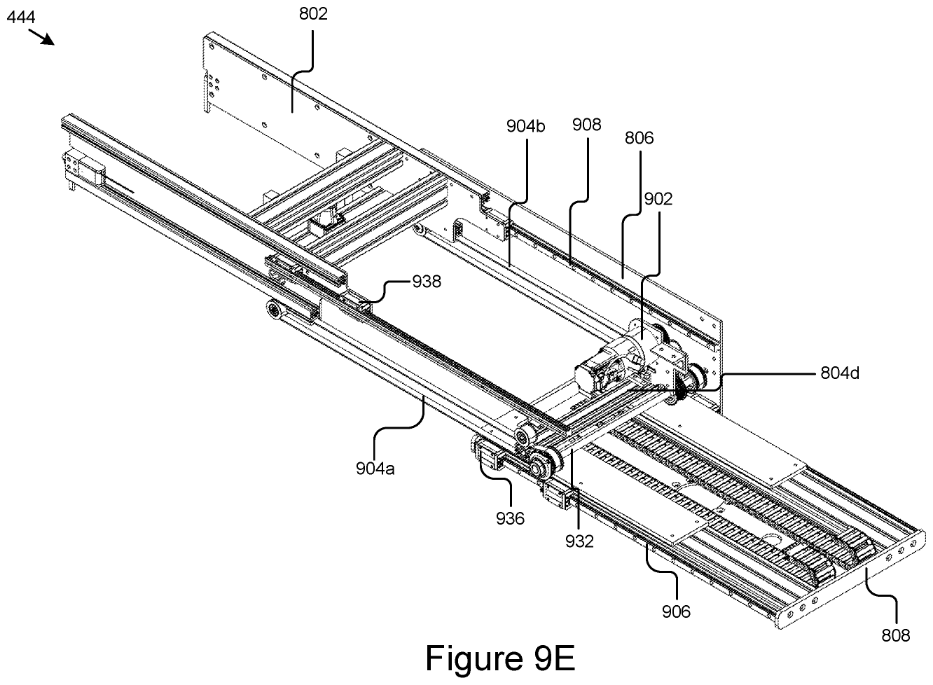

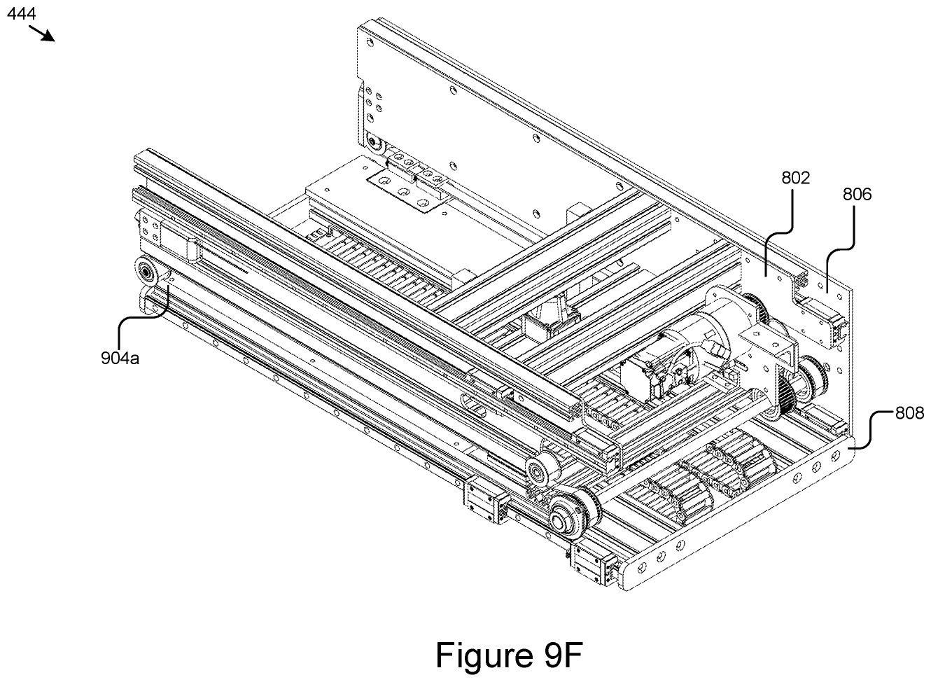

As illustrated, an item handling mechanism 444 may include one or more internal side members 802a and 802b, which may be coupled together using one or more cross braces 804. The internal side members 802 may also be coupled with a floor or other support that may support an item. The internal side members 802 and/or associated structures may represent an example implementation of one or more extendable arm(s). For instance, the internal side members 802 may telescope outward from a base 808 of the item handling mechanism 444. A base 808 may couple with a rotatable platform 712 (not visible), so that the external sides 806 and the internal sides 802 extend therefrom, as illustrated and described elsewhere herein. In some implementations, the internal side members 802 may be slidably coupled with one or more external side members 806a and 806b via belts, linear rails, or other structures, as described in further detail in reference to FIGS. 9A-9F below.

The internal side members 802 may be vertical plates or other structures frames that extend outward to interact with an item. In some instances, the internal side members 802 may include or hold one or more grasping mechanisms. For instance, a grasping mechanism may include a suction cup, grasping clamp, or fingers 812, such are illustrated in the examples of FIGS. 8A-8D, or other device. For instance, as shown in FIG. 8D, the fingers 812a and 812b may pivot between a vertical, open position and a horizontal closed (e.g., actuated or grasping) position. FIG. 8D shows the fingers 812a and 812b in a horizontal closed position that allows them to keep an item with the interior side members 802, thereby pulling it off a shelf. Depending on the implementation, the fingers 812 may be coupled with a motor 814 that slides with (e.g., coupled with a cross brace 804) the internal side members 802 and actuates the fingers 812. For instance, one or more driveshafts and gears couple the motor 814 with one or more of the fingers 812. Advantageously, the fingers 812 are reliable, slim, and may travel with telescoping components of the item handling mechanism 444.

In some implementations, as shown in FIG. 8D, one or more pushing members 816 may be coupled with a cross support 804 and/or internal side members 802 and used to contact a surface of an item and push it as the internal side members 802 are extended.

FIGS. 8F, 8G, and 8H illustrate the item handling mechanism 444 rotated relative to the vertical carriage 442, for example, so that it faces the vertical support rail(s) 434 and/or may access a mobile conveyor.

FIG. 8F illustrates a perspective view of an example item handling mechanism 444 coupled with an example vertical carriage 442. As shown, a rotating platform 712 coupled with a base 808, has rotated the base and other components of the item handling mechanism 444. As illustrated, the motor 714 may extend through the rotating platform 712 to interact with a belt 716 and may be coupled with the platform 712 vertically, so that it is positioned to a side of an external side member 806. Accordingly, because the motor 714 may rotate with the rest of the item handling mechanism 444, it is accessible while not impeding its movement.

For example, FIG. 8G illustrates a perspective view of the vertical carriage 442 mounted to a mast 416 and positioned at a height to match a top mobile conveyor 454 to place items thereon or retrieve items therefrom. FIG. 8H also shows a perspective view of the vertical carriage 442 mounted to vertical support rails 434 and carrying the item handling mechanism 444 in a rotation toward the vertical support rails 434a and 434b, so that the item handling mechanism 444 may extend between the vertical support rails 434a and 434b to place an item on 406 on a mobile conveyor (not shown in FIG. 8H).

FIGS. 9A-9F illustrate various views of an item handling mechanism 444 in a retracted and extended position as well as various components that facilitate its extension/telescoping functionality. Although other components and features are possible, the illustrated examples provide stability and significant range of motion to allow the item handling mechanism 444 to access a back shelf (and/or front shelf) in a double-deep shelving/storage arrangement.

FIG. 9A illustrates a perspective view of an example item handling mechanism 444 holding an item 406 in a retracted state. As shown, the external side member(s) 806 and internal side member(s) 802 are retracted to be adjacent to/above a base 808.

FIGS. 9B and 9C illustrate a top perspective view and bottom perspective view, respectively, of the item handling mechanism 444 in a fully extended position. As illustrated, the base 808, which may include one or more frames, plates, wire chases, or other devices is illustrated in a non-extended position because it may be attached with the rotatable platform 712.

The external side member(s) 806 may be extended relative to the base 808. For instance, the external side member(s) 806 may be coupled with the base 808 via one or more linear rails 906 along which they may slide to allow the external side member(s) 806 to extend outward. In some implementations, a motor 902 may be coupled with the external side member(s) 806 and move with the member(s) 806. For example, the motor 902 may turn one or more belts 904 (e.g., coupled together using a driveshaft) that extend along the external side member(s) 806 and couple with both the base 808 and the internal side member(s) 802. For instance, a base 808 may be coupled on a bottom side of a belt 904 while an internal side member 802 may be coupled on a top side of the belt 904, so that when the belt is rotated in a first direction, they move apart, and when the belt 904 is rotated in the opposite direction, they move toward one another.

For example, the internal side member(s) 802 may be coupled with the external side member(s) 806 via one or more second linear rails 908. The internal side member(s) 802 may be coupled with the belt 904, as noted above and in further detail below to cause it to extend or retract as the belt 904 is rotated by the motor 902.

FIG. 9D illustrated an end-on view of an extended item handling mechanism 444. As shown, internal side members 802a and 802b are shown in a fully extended position. Cross supports 804a, 804b, and 804c are illustrated coupling the side members 802a and 802b together, supporting a motor 814 and one or more pushing member 816. In the illustrated implementation, the motor 814 may move with the internal side members 802 into an extended position to allow the motor 814 to drive the fingers 812a and 812b, for example, via one or more gears and/or driveshafts (e.g., extending horizontally and then longitudinally along the side members 802).

As shown, the base 808 may house various components, such as wire chases and drag chains that allow the motors 814 and 902 to remain plugged in while the item handling mechanism 444 moves between a retracted and extended position.

FIG. 9E illustrates a perspective view of an example item handling mechanism 444 in an extended position with various components hidden to display example action of the belt 904 and other components. For instance, a motor 902 is shown coupled via a set of gears and a belt/chain to a driveshaft 932, which allows the motor 902 to drive multiple belts 904a and 904b, so that the telescoping mechanism is less likely to bind or become out of alignment. The motor 902 may be attached to a cross support 804d that couples the external side members 806 together, so that it moves with the external side members 806 along with the belt(s) 904 and other hardware, as shown in the example.

Each of the belts 904a and 904b may include a gear, a tensioning pulley, and an end pulley, so that the motor 902 may rotate both belts 904a and 904b together. It should be noted that although the term belt or chain are used herein, they may be interchanged or replaced with similar mechanisms, such as a driveshaft, worm gear, hydraulics, or otherwise.

In the illustrated example, the base 808 may be coupled with the belt(s) 904 via one or more belt clamps 936 to cause the belt(s) 904 to move relative to the base 808. Similarly, the internal side member(s) 802 may be coupled with the belt(s) 904 via one or more second belt clamps 938.

FIG. 9F illustrates a perspective view of an example item handling mechanism 444 in a retracted position with various components hidden to display an example configuration of the belt 904 and other components. As shown, the belt 904a has rotated to pull the side members 802 and 806 backward, as described in further detail above. When in a retracted state, the interior side member(s) 802 and external side member(s) 806 may be nested next to and/or above one another and the base 808 to allow the item handling mechanism 444 to fit in a compact space.

It should be noted that these configurations, for example, of the item handling mechanism 444 and/or vertical carriage 442 are provided by way of examples and that configurations are possible and contemplated herein. For instance, vertical carriage may travel up/down four posts and may include one or more staging shelves or conveyors (e.g., traveling with the vertical carriage) to which items may be placed by an item handling head or other mechanism to allow additional items to be carried or staged while shuffling from deeper shelves. Similarly, other mechanisms for rotating the item handling head or extending it/its arms may alternatively be used.

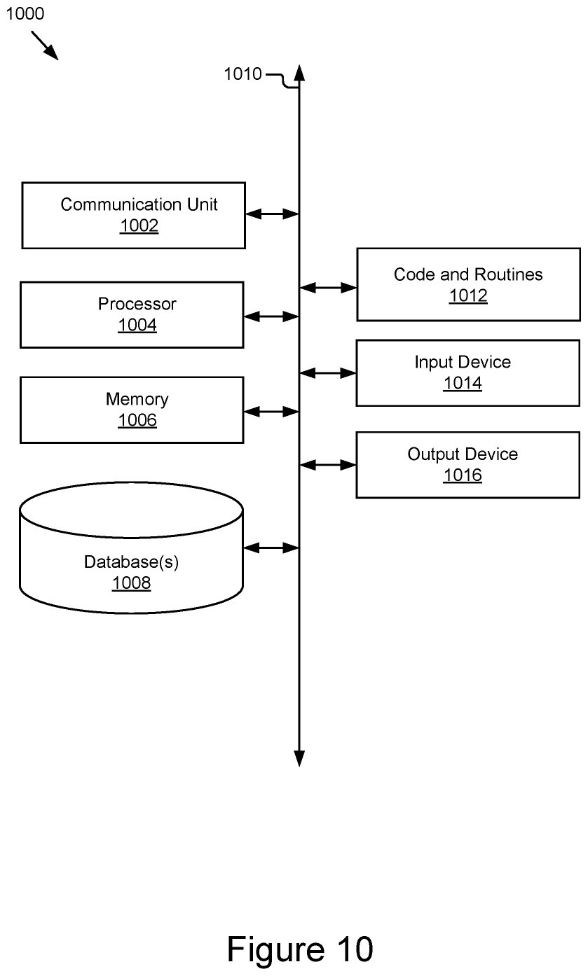

FIG. 10 is a block diagram illustrating an example computing system 1000. The example computing system 1000 may correspond to a WES 102, a WMS 104, a dispatch system 106, a human interface system 108, equipment controller(s) 110, ASRS vehicle controller(s) 142, REX server 118, a client device, a computing device of a picking station, a computing device of a robotic arm, a computing device/controller of an AGV or ASRS, or other component of the system 100, for example.

The code and routines 1012 may include computer logic executable by the processor 1004 on a computing system 1000 to provide for the functionality described in reference to one or more of the components of the system 100. For instance, in some implementations, the code and routines may include one or more of the components of the WES 102, equipment controller(s) 110, ASRS vehicle controller 142, or other system(s) for controlling the ASRS and/or components thereof.

As depicted, the computing system 1000 may include a processor 1004, a memory 1006, a communication unit 1002, an output device 1016, an input device 1014, and database(s) 1008, which may be communicatively coupled by a communication bus 1010. The computing system 1000 depicted in FIG. 10 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 1000 may include various operating systems, sensors, additional processors, and other physical configurations. Although, for purposes of clarity, FIG. 10 only shows a single processor 1004, memory 1006, communication unit 1002, etc., it should be understood that the computing system 1000 may include a plurality of one or more of these components.

The processor 1004 may execute software instructions by performing various input, logical, and/or mathematical operations. The processor 1004 may have various computing architectures to process data signals including, for example, a complex instruction set computer (CISC) architecture, a reduced instruction set computer (RISC) architecture, and/or an architecture implementing a combination of instruction sets. The processor 1004 may be physical and/or virtual, and it may include a single core or plurality of processing units and/or cores. In some implementations, the processor 1004 may be capable of generating and providing electronic display signals to a display device, supporting the display of images, capturing and transmitting images, performing complex tasks including various types of feature extraction and sampling, etc. In some implementations, the processor 1004 may be coupled to the memory 1006 via the bus 1010 to access data and instructions therefrom and store data therein. The bus 1010 may couple the processor 1004 to the other components of the computing system 1000 including, for example, the memory 1006, the communication unit 1002, the input device 1014, the output device 1016, and the database(s) 1008.

The memory 1006 may store and provide access to data to the other components of the computing system 1000. The memory 1006 may be included in a single computing device or a plurality of computing devices. In some implementations, the memory 1006 may store instructions and/or data that may be executed by the processor 1004. For example, the memory 1006 may store the code and routines 1012. The memory 1006 is also capable of storing other instructions and data, including, for example, an operating system, hardware drivers, other software applications, databases, etc. The memory 1006 may be coupled to the bus 1010 for communication with the processor 1004 and the other components of computing system 1000.

The memory 1006 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 1004. In some implementations, the memory 1006 may include one or more of volatile memory and non-volatile memory (e.g., RAM, ROM, hard disk, optical disk, etc.). It should be understood that the memory 1006 may be a single device or may include multiple types of devices and configurations.

The bus 1010 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 1002 may include one or more interface devices (I/F) for wired and wireless connectivity among the components of the system 100. For instance, the communication unit 1002 may include various types of connectivity and interface options. The communication unit 1002 may be coupled to the other components of the computing system 1000 via the bus 1010. The communication unit 1002 may be electronically communicatively coupled to a network (e.g., wiredly, wirelessly, etc.). In some implementations, the communication unit 1002 can link the processor 1004 to a network, which may in turn be coupled to other processing systems. The communication unit 1002 can provide other connections to a network and to other entities of the system 100 using various standard communication protocols.

The input device 1014 may include any device for inputting information into the computing system 1000. In some implementations, the input device 1014 may include one or more peripheral devices. For example, the input device 1014 may include a keyboard, a pointing device, microphone, an image/video capture device (e.g., camera), a touch-screen display integrated with the output device 1016, optical scanner, barcode reader, QR™ code reader, RFID (radio-frequency identification) tag reader, etc. In some implementations, the input device 1014 may receive sensor data from one or more sensors.

The output device 1016 may be any device capable of outputting information from the computing system 1000. The output device 1016 may include one or more of a display (LCD, OLED, etc.), a printer, a 3D printer, a haptic device, audio reproduction device, touch-screen display, etc. In some implementations, the output device is a display which may display electronic images and data output by the computing system 1000 for presentation to a user, such as a picker or associate in the order fulfillment center. In some implementations, the computing system 1000 may include a graphics adapter (not shown) for rendering and outputting the images and data for presentation on output device 1016. The graphics adapter (not shown) may be a separate processing device including a separate processor and memory (not shown) or may be integrated with the processor 1004 and memory 1006. In some implementations, the output device 1016 may provide signals to control various motors, actuators, or other devices.

The database(s) are information source(s) for storing and providing access to data. The data stored by the database(s) 1008 may be organized and queried using various criteria including any type of data stored by them, such as the data in the data store 120 and other data discussed herein. The database(s) 1008 may include file systems, data tables, documents, databases, or other organized collections of data. Examples of the types of data stored by the database(s) 1008 may include the data described herein, for example, in reference to the data store 120.

The database(s) 1008 may be included in the computing system 1000 or in another computing system and/or storage system distinct from but coupled to or accessible by the computing system 1000. The database(s) 1008 can include one or more non-transitory computer-readable mediums for storing the data. In some implementations, the database(s) 1008 may be incorporated with the memory 1006 or may be distinct therefrom. In some implementations, the database(s) 1008 may store data associated with a database management system (DBMS) operable on the computing system 1000. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A system comprising:
a mobile vehicle body including a first mobile conveyor that moves with the mobile vehicle body;
an item handling mechanism coupled with the mobile vehicle body and including one or more extendable members that move between a retracted position and an extended position to retrieve one or more items from one or more external shelves and move the one or more items onto the first mobile conveyor; and
one or more driving wheels coupled with a drive motor that cause the mobile vehicle body, mobile conveyor, and the item handling mechanism to move in an aisle.

2. The system of claim 1, wherein the mobile vehicle body includes:
one or more guide wheels oriented horizontally to contact one or more external guide rails extending down a length of the aisle, the one or more external guide rails aligning the mobile vehicle body in the aisle.

3. The system of claim 1, wherein the system further comprises:
one or more vertical support rails coupled with and extending vertically from the mobile vehicle body;
a vertical carriage coupled with and moving vertically along the one or more vertical support rails, the vertical carriage holding the item handling mechanism; and
a second motor mounted to the mobile vehicle body and adapted to drive a belt extending along the one or more vertical support rails, the vertical carriage coupled with the belt.

4. The system of claim 1, wherein the mobile vehicle body includes:
two or more mobile conveyors coupled with a frame of the mobile vehicle body, each of the two or more mobile conveyors being accessible to the item handling mechanism, the two or more mobile conveyors including the first mobile conveyor and a second mobile conveyor, the first mobile conveyor being located vertically above the second mobile conveyor.

5. The system of claim 4, wherein the item handling mechanism is configured to remove an item from the second mobile conveyor and place the item on the first mobile conveyor.

6. The system of claim 1, wherein:
the one or more extendable members include one or more grasping fingers at an end of the one or more extendable members, the one or more grasping fingers pivoting between a vertical position and a horizontal position, the horizontal position providing contact with the one or more items handled by the item handling mechanism, the contact pulling the one or more items from the one or more external shelves when the item handling mechanism moves into the retracted position.

7. The system of claim 6, wherein:
the one or more extendable members include one or more linear rails supporting one or more telescoping side members, a belt, and a motor engaging with the belt, the one or more telescoping side members being coupled with the belt so that when the motor rotates the belt, the belt causes the one or more telescoping side members to extend along the one or more linear rails and move the item handling mechanism into the extended position.

8. The system of claim 1, further comprising:
a vertical carriage moving vertically along a vertical support rail, the vertical support rail extending vertically upward from the mobile vehicle body, the vertical carriage including a horizontal platform extending horizontally away from the vertical support rail, the horizontal platform providing vertical support to the item handling mechanism.

9. The system of claim 8, further comprising:
a first horizontal gear coupled with the horizontal platform and mounted in a horizontal orientation, the item handling mechanism including a motor that engages with the first horizontal gear to cause the item handling mechanism to rotate relative to the first horizontal gear, the rotation of the item handling mechanism allowing the one or more extendable members to extend in along two or more different directions.

10. The system of claim 9, further comprising:
wherein a second horizontal gear is mounted to the motor and interacts with a belt, the belt extending around the first horizontal gear and the second horizontal gear, the motor being coupled with and rotating with the item handling mechanism, the motor causing the item handling mechanism to rotate relative to the horizontal platform when the motor rotates the second horizontal gear, the first horizontal gear being rigidly mounted to the horizontal platform.

11. The system of claim 1, wherein:
the one or more extendable members of the item handling mechanism have a reach length configured to extend into one or more external storage shelves, the one or more external storage shelves including a front storage shelf and a back storage shelf, the one or more extendable members being adapted to access both the front storage shelf and the back storage shelf, the back storage shelf including the one or more external shelves from which the one or more items are retrieved by the item handling mechanism.

12. The system of claim 1, wherein:
the one or more driving wheels are configured to move the mobile vehicle body to an unloading zone at which the first mobile conveyor rotates to transfer the one or more items off from the first mobile conveyor.

13. A method comprising:
retrieving a first item from a first location on one or more external storage shelves using an item handling mechanism coupled with a mobile vehicle;
transferring the first item from the item handling mechanism to a first mobile conveyor coupled with the mobile vehicle;
navigating the mobile vehicle to a transfer location; and
transferring the first item from the first mobile conveyor including rotating the first mobile conveyor at the transfer location.

14. The method of claim 13, further comprising:
retrieving a second item from a second location on the one or more external storage shelves using the item handling mechanism; and
transferring the second item from the item handling mechanism to the first mobile conveyor, the first mobile conveyor holding the first item and the second item simultaneously.

15. The method of claim 14, further comprising:
transferring the second item with the first item from the first mobile conveyor including rotating the first mobile conveyor at the transfer location.

16. The method of claim 13, further comprising:
transferring a second item from a second mobile conveyor coupled with the mobile vehicle to the first mobile conveyor using the item handling mechanism.

17. The method of claim 16, wherein transferring the second item from the second mobile conveyor to the first mobile conveyor includes:
moving the item handling mechanism to a first height of the second mobile conveyor;
rotating the second mobile conveyor to position the second item within reach of the item handling mechanism;
extending the item handling mechanism to interact with the second item on the second mobile conveyor;
retracting the item handling mechanism holding the second item;
moving the item handling mechanism to a second height of the first mobile conveyor; and
extending the item handling mechanism to move the second item onto the first mobile conveyor.

18. The method of claim 13, further comprising:
retrieving a second item from a second location on the one or more external storage shelves using the item handling mechanism; and
transferring the second item from the item handling mechanism to a second mobile conveyor coupled with the mobile vehicle.

19. The method of claim 18, wherein:
the second item is retrieved from a front storage shelf and the first item is retrieved from a back storage shelf of the one or more external storage shelves;
the first item is an assigned item for retrieval by the item handling mechanism and the second item is an unassigned item; and
the second item is retrieved by the item handling mechanism prior to the first item being retrieved by the item handling mechanism.

20. The method of claim 19, further comprising:
retrieving the second item from the second mobile conveyor using the item handling mechanism;
moving the item handling mechanism holding the second item to a height of the front storage shelf;
rotating the item handling mechanism to face the item handling mechanism toward the front storage shelf; and
extending the item handling mechanism and the second item to place the second item on the front storage shelf.
